(19) United States
(12) Patent Application Publication
(10) Pub. No.: US 2026/0195565 A1
(43) Pub. Date: Jul. 9, 2026

(54) SYSTEMS AND METHODS FOR DYNAMIC TOKEN ROUTING NETWORK

(71) Applicant: HUAWEI TECHNOLOGIES CO., LTD., SHENZHEN (CN)

(72) Inventors: Aref JAFARI, Kanata (CA); Mehdi REZAGHOLI ZADEH, Kanata (CA); Aman SHARMA, Kanata (CA); Yuhe FAN, Kanata (CA); Benyamin JAMIALAHMADI, Kanata (CA); Boxing CHEN, Kanata (CA); Saeed NAJAFI, Kanata (CA)

(73) Assignee: HUAWEI TECHNOLOGIES CO., LTD., SHENZHEN (CN)

(21) Appl. No.: 19/214,430

(22) Filed: May 21, 2025

Related U.S. Application Data
(60) Provisional application No. 63/743,068, filed on Jan. 8, 2025.

(51) Int. Cl. G06N 3/0455; G06N 3/09

(52) U.S. Cl. CPC G06N 3/0455; G06N 3/09

(57) ABSTRACT

Embodiments provide systems and methods for a dynamic token routing network, enhanced model architectures, and improved batch inferencing in the field of machine learning. Embodiments include assigning computational priorities to input tokens based on their significance and dynamically routing high-priority tokens to a quadratic processing block for detailed embeddings, while routing low-priority tokens to a sub-quadratic block. The outputs are subsequently merged to generate context-aware embeddings while preserving the original token sequence order. Enhanced transformer model architectures are provided, incorporating attention blocks for context-aware token representations, token mixers for efficient processing, and multilayer perceptrons for feature extraction and refinement. Batch inferencing techniques are introduced, grouping sequences of varying lengths into partitions. This approach may reduce padding requirements, which may reduce computational overhead and ensures sequence integrity during attention computation. Embodiments may improve machine learning model performance and enable scalable and efficient processing for diverse applications.

### CROSS-REFERENCE TO RELATED APPLICATIONS

This application claims the benefit of and priority to U.S. Provisional Patent Application No. 63/743,068 filed on Jan. 8, 2025, the contents of which are incorporated herein by reference in their entirety.

### FIELD OF THE DISCLOSURE

The present application pertains to machine learning, and in particular to methods, systems and apparatus for dynamic token routing network (DTRNet), enhanced model architecture and batch inferencing techniques.

### BACKGROUND

As large language models (LLMs) models grow to billions of parameters, achieving efficient inference has become increasingly important, particularly for applications involving large input sequences. LLMs are typically based on transformer architectures, which use self-attention mechanisms to compute relationships between tokens in a sequence. This self-attention mechanism scales quadratically with sequence length, creating potential challenges in terms of memory and computation, especially for long input sequences.

In transformer-based models, including those used for LLMs, processing is often applied uniformly across the entire sequence. This “one-size-fits-all” approach simplifies implementation but leads to inefficiencies. Treating all tokens equally in terms of computational effort can result in unnecessary processing, increased inference time, and higher energy consumption, particularly when different tokens require varying levels of attention to achieve optimal performance.

Some existing methods attempt to reduce computational overhead by focusing more resources on certain parts of the sequence or terminating processing early for less critical tokens. However, these techniques have limitations. For instance, reducing computation on parts of the sequence may lead to incomplete processing of important contextual relationships, while early termination may undermine the accuracy of predictions, especially when dependencies are complex.

Additionally, these methods often struggle to scale for batch inference. Variability in how sequences are processed can impede parallelism, and padding sequences to standardize their lengths negates the computational benefits, reducing performance for high-throughput applications.

Therefore, there is a need for methods, systems and apparatuses for a dynamic token routing network (DTRNet), enhanced model architecture and an improved batch inferencing approach that obviates or mitigates one or more limitations of the prior art.

This background information is provided to reveal information believed by the applicant to be of possible relevance to the present application. No admission is necessarily intended, nor should be construed, that any of the preceding information constitutes prior art against the present application.

### SUMMARY

According to embodiments, systems and methods are provided for dynamic token routing network, enhanced model architectures and improved batch inferencing. According to embodiments, a method is provided for processing one or more sequences of input tokens by a transformer model, where the transformer model includes a plurality of layers. The method may be performed at a layer of the plurality of layers. The method includes processing, by a quadratic processing block, a first set of input tokens from each sequence of the one or more sequences to generate a first set of outputs representing high-priority token embeddings associated with the first set of input tokens. The quadratic processing block may perform computation that scales quadratically with respect to a number of input tokens processed. For example, the quadratic processing block may process the first set of input tokens based on computation that scales quadratically with respect to a number of input tokens in the first set. The method further includes processing, by a sub-quadratic processing block using a multiplayer perceptron (MLP) block, information (e.g., xₗ as in the case of FIG. 3A or Vₗ as in the case of FIG. 3B/C) derived from a second set of input tokens from said each sequence of the one or more sequences to generate a set of adjustment values (e.g., a set of residual vectors) associated with the second set of input tokens. Each adjustment value of the set of adjustment values (e.g., each residual vector of the set of residual vectors) may correspond to an input token of the second set of input tokens and represent an adjustment to said input token. The second set of input tokens may include input tokens other than the first set of input tokens. The method further includes processing, by the sub-quadratic processing block, the second set of input tokens and the set of adjustment values (residual vectors) to generate a second set of outputs representing low-priority token embeddings associated with the second set of input tokens. Each output of the second set of outputs may be generated based on a corresponding input token of the second set of input tokens and a corresponding adjustment of the set of adjustment values (e.g., a corresponding residual vector of the set of residual vectors corresponding to said input token of the second set of input tokens). The method further includes processing, by a merge block, the first set of outputs and the second set of outputs to generate a third set of outputs representing combined embeddings arranged based on an original order of said each sequence of the one or more sequences.

In some embodiments, processing, by the quadratic processing block, the first set of input tokens from each sequence of the one or more sequences to generate the first set of outputs includes processing, by the quadratic processing block using an attention block, the first set of input tokens to generate a set of attention outputs indicating context-aware representations of the first set of input tokens. In some embodiments, processing, by the quadratic processing block, the first set of input tokens from each sequence of the one or more sequences to generate the first set of outputs further includes processing, by the quadratic processing bloc using a second MLP block, the set of attention outputs to generate the first set of outputs, each output of the first set of outputs representing a learned feature associated with an attention output of the set of attention outputs.

In some embodiments, processing, by the quadratic processing block, the first set of input tokens from each sequence of the one or more sequences to generate the first set of outputs includes determining, using an attention block, a Q matrix and a K matrix based on the first set of input tokens. In some embodiments, processing, by the quadratic processing block, the first set of input tokens from each sequence of the one or more sequences to generate the first set of outputs further includes determining, using the attention block, a V matrix based on all input tokens of the one or more sequences. In some embodiments, processing, by the quadratic processing block, the first set of input tokens from each sequence of the one or more sequences to generate the first set of outputs further includes processing, using the MLP block, the set of attention outputs to generate the first set of outputs.

In some embodiments, processing information derived from the second set of input tokens includes processing the second set of input tokens by the MLP block to generate the set of adjustment values, and wherein generating the second set of outputs comprises adding each adjustment value to the corresponding input token from the second set.

In some embodiments, processing information derived from the second set of input tokens includes obtaining intermediate values based at least in part on the second set of input tokens, wherein the intermediate values are based on a V matrix determined by the quadratic processing block and based on all input tokens of the one or more sequences. In some embodiments, processing information derived from the second set of input tokens further includes processing said intermediate values using the MLP block (in the sub-quadratic processing block) to generate the set of adjustment values.

In some embodiments, the method further includes receiving, by a router, the one or more sequences of input tokens. In some embodiments, the method further includes assigning, by the router, a score to each input token of said each sequence of the one or more sequences of input tokens, the score indicating a computational priority of said each input token. In some embodiments, the method further includes selecting or identifying, by the router, the first set of input tokens from said each sequence of the one or more sequences. In some embodiments, the identifying each input token of the first set of input tokens is based on a score (e.g., the assigned score) exceeding a priority threshold indicating a high-priority token. In some embodiments, the method further includes selecting and/or identifying, by the router, the second set of input tokens from said each sequence of the one or more sequences for routing to the sub-quadratic processing block.

In some embodiments, the method further includes routing the first set of input tokens to the quadratic processing block, and routing the second set of input tokens to the sub-quadratic processing block.

In some embodiments, the method further includes routing the second set of input tokens to the sub-quadratic processing block. In some embodiments, the method further includes routing the one or more sequences to the quadratic processing block, wherein the first set of input tokens is indicated to the quadratic processing block.

In some embodiments, the router is trained based on selecting, by the router, the first set of input tokens from said each sequence of the one or more sequences. In some embodiments, the selecting of the first set of input tokens is based on an upper threshold representing a maximum amount of input tokens from said each sequence of the one or more sequences of input tokens that can be part of the first set of input tokens. In some embodiments, the selecting of the first set of input tokens is further based on a dynamic batch threshold representing a maximum amount of high-priority tokens in any one sequence of the one or more sequences, each high-priority token referring an input token with a score (e.g., the assigned score) exceeding the priority threshold. In some embodiments, a number of the first set of input tokens is the upper threshold if the dynamic batch threshold exceeds the upper threshold. In some embodiments, a number of the first set of input tokens is the dynamic batch threshold if the dynamic batch threshold is less than or equal to the upper threshold.

In some embodiments, the router is machine learning model that is further trained based on updating one or more weights of the machine learning model according to a regularization term.

In some embodiments, the regularization term is as follows

$${\sum }_{i = 1}^{L} {\sum }_{j = 1}^{m} {‖ {\vec{g}}_{ij} ‖}_{2}^{2} ,$$

where: L is a number of layers of the plurality of layers of the transformer model, m is a number of sequences of the one or more sequences, \vec{g}ᵢⱼ is an output score vector for the i-th layer and the j-th sequence in the one or more sequences, and

$${‖ \cdot ‖}_{2}^{2}$$

denotes squared L2 norm of the output score vector.

According to embodiments, a transformer model is provided for processing one or more sequences of input tokens. The transformer model includes a plurality of layers, and at least one layer of the plurality of layers includes a quadratic processing block configured to process a first set of input tokens from each sequence of the one or more sequences to generate a first set of outputs representing high-priority token embeddings associated with the first set of input tokens. The quadratic processing block may further be configured to perform computation that scales quadratically with respect to a number of input tokens processed. For example, the quadratic processing block may process the first set of input tokens based on computation that scales quadratically with respect to a number of input tokens in the first set. The at least one layer of the plurality of layers further includes a sub-quadratic processing block configured to process, using a multilayer perceptron (MLP) block, a second set of input tokens from said each sequence of the one or more sequences to generate a set of residual vectors. Each residual vector of the set of residual vectors corresponds to an input token of the second set of input tokens and represents an adjustment to said input token. The second set of input tokens includes input tokens other than the first set of input tokens. The sub-quadratic processing block may further be configured to process, the second set of input tokens and the set of residual vectors to generate a second set of outputs representing low-priority token embeddings associated with the second set of input tokens. Each output of the second set of outputs being generated based on an input token of the second set of input tokens and a residual vector of the set of residual vectors corresponding to said input token of the second set of input tokens. The at least one layer of the plurality of layers further includes a merge block configured to process the first set of outputs and the second set of outputs to generate a third set of outputs representing combined embeddings arranged based on an original order of said each sequence of the one or more sequences.

In some embodiments, the quadratic processing block includes an attention block configured to process the first set of input tokens to generate a set of attention outputs indicating context-aware representations of the first set of input tokens. In some embodiments, the quadratic processing block further includes a second MLP block configured to process the set of attention outputs to generate the first set of outputs, each output of the first set of outputs representing a learned feature associated with an attention output of the set of attention outputs.

In some embodiments, the at least one layer of the plurality of layers further includes a router configured to receive the one or more sequences of input tokens. In some embodiments, the router is further configured to assign a score to each input token of said each sequence of the one or more sequences of input tokens, the score indicating a computational priority of said each input token. In some embodiments, the router is further configured to select the first set of input tokens from said each sequence of the one or more sequences for routing to the quadratic processing block, each input token of the first set of input tokens having a score (e.g., the assigned score) exceeding a priority threshold indicating a high-priority token. In some embodiments, the router is further configured to select each input token of the first set of input tokens based on the assigned score exceeding a priority threshold, which indicates a high-priority token. In some embodiments, the router is further configured to select the second set of input tokens from said each sequence of the one or more sequences for routing to the sub-quadratic processing block.

According to another aspect, an apparatus is provided which includes at least one processor and at least one machine-readable medium storing instructions which when executed by the at least one processor configure the apparatus for processing one or more sequences of input tokens using a transformer model comprising a plurality of layers, wherein execution of the instructions configures the apparatus for, at a layer of the plurality of layers, performing one or more methods described herein.

According to another aspect, a (e.g., non-transitory) computer readable medium, computer program, or computer program product, includes stored thereon statements and instructions which, when executed by a computer processor perform one or more methods described herein. For example, the execution of the statements and/or instructions may cause processing one or more sequences of input tokens using a transformer model according to one or more embodiments described herein.

According to another aspect, an apparatus or system is provided, where the apparatus includes modules configured to perform one or more methods described herein. According to another aspect, another apparatus or system is provided that includes computing electronics and is configured to perform the methods described herein. According to another aspect, another apparatus is provided that includes processing and wireless communication electronics and is configured to operate as described herein.

In some embodiments a computer program product is provided. The computer program product includes a non-transitory computer readable medium having recorded thereon statements and instructions which, when executed by a computer, cause the computer to perform one or more methods described herein.

According to another aspect, a chip is provided, where the chip includes a processor and a data interface, and the processor reads, by using the data interface, an instruction stored in a memory, to perform the different aspects described herein.

Other aspects of the application provide for apparatus, and systems configured to implement the methods according to the different aspects disclosed herein. For example, wireless stations and access points can be configured with machine readable memory containing instructions, which when executed by the processors of these devices, configures the device to perform the methods disclosed herein.

Embodiments have been described above in conjunctions with aspects of the present application upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present application will become apparent from the following detailed description, taken in combination with the appended drawings, in which:

FIG. 1 illustrates a dynamic token routing network (DTRNet) layer, according to an embodiment.

FIGS. 2A and 2B illustrate a batch inference approach, according to an embodiment.

FIG. 3A illustrates a DTRNet-Adaptor layer, according to an embodiment.

FIG. 3B illustrates an alternative DTRNet-Adaptor layer, according to an embodiment.

FIG. 3C illustrates operations of an attention module, according to an embodiment.

FIG. 4 illustrates a DTRNet-Mamba layer, according to an embodiment.

FIG. 5 illustrates an example configuration for training a DTRNet-based model using a knowledge distillation framework, according to an embodiment.

FIG. 6A illustrates a method for training a machine learning model for dynamically routing tokens, according to an embodiment.

FIG. 6B illustrates a method for processing one or more sequences of input tokens, according to an embodiment.

FIG. 6C illustrates another method for processing one or more sequences of input tokens, according to an embodiment.

FIG. 6D illustrates a method for concurrently processing a plurality of sequences of varying lengths at a layer of a model during inference, according to an embodiment.

FIG. 6E illustrates another method for concurrently processing a plurality of sequences of varying lengths at a layer of a model during inference, according to an embodiment.

FIG. 7 illustrates a schematic structural diagram of a system architecture, according to an embodiment.

FIG. 8 illustrates a schematic diagram of a hardware structure of a chip, according to an embodiment.

FIG. 9 illustrates a schematic diagram of a hardware structure of a training apparatus, according to an embodiment.

FIG. 10 illustrates a schematic diagram of a hardware structure of an execution apparatus, according to an embodiment.

FIG. 11 illustrates a system architecture, according to an embodiment.

It will be noted that throughout the appended drawings, like features are identified by like reference numerals.

### DETAILED DESCRIPTION

According to embodiments, systems and methods are provided for dynamic token routing network, enhanced model architectures and improved batch inferencing. According to embodiments, a method is provided for training a machine learning model for dynamically routing tokens. The method includes receiving, by a machine learning model for example, one or more sequences of input tokens. The method further includes assigning, by the machine learning model, a score to each input token of each sequence of the one or more sequences of input tokens, the score indicating a computational priority of said each input token. The method further includes selecting, by the machine learning model, a first set of input tokens from said each sequence of the one or more sequences for routing to a first processing block. In some embodiments, the selecting is based on an upper threshold representing a maximum amount of input tokens from said each sequence of the one or more sequences of input tokens that can be routed to the first processing block. In some embodiments, the selecting is further based on a dynamic batch threshold representing a maximum amount of high-priority tokens in any one sequence of the one or more sequences, each high-priority token referring an input token with a score (e.g., the assigned score) exceeding a priority threshold. The method further includes selecting, by the machine learning model, a second set of input tokens from said each sequence of the one or more sequences for routing to a second processing block.

According to embodiments, a method is provided for processing one or more sequences of input tokens. The method includes processing, by a quadratic processing block, a first set of input tokens from each sequence of the one or more sequences to generate a first set of outputs representing high-priority token embeddings associated with the first set of input tokens. The quadratic processing block may be configured to perform computation that scales quadratically with respect to a number of input tokens processed. For example, the quadratic processing block may process the first set of input tokens based on computation that scales quadratically with respect to a number of input tokens in the first set. The method further includes processing, by a sub-quadratic processing block using a multiplayer perceptron (MLP) block, a second set of input tokens from said each sequence of the one or more sequences to generate a set of residual vectors. Each residual vector of the set of residual vectors may correspond to an input token of the second set of input tokens and represent an adjustment to said input token. The second set of input tokens includes input tokens other than the first set of input tokens. The method further includes processing, by the sub-quadratic processing block, the second set of input tokens and the set of residual vectors to generate a second set of outputs representing low-priority token embeddings associated with the second set of input tokens. Each output of the second set of outputs may be generated based on an input token of the second set of input tokens and a residual vector of the set of residual vectors corresponding to said input token of the second set of input tokens. The method further includes processing 614, by a merge block, the first set of outputs and the second set of outputs to generate a third set of outputs representing combined embeddings arranged based on an original order of said each sequence of the one or more sequences.

According to embodiments, another method is provided for processing one or more sequences of input tokens. The method may be performed by a transformer model at a layer of a plurality of layers of the transformer model. The method includes processing, by an attention block, a first set of input tokens from each sequence of the one or more sequences to generate a first set of outputs indicating context-aware representations of the first set of input tokens. The method further includes processing, by a mamba token mixer block, a second set of input tokens from each sequence of the one or more sequences to generate a second set of outputs, the second set of input tokens including all input tokens of said each sequence of the one or more sequences. The method further includes processing, by a merge block, the first set of outputs and the second set of outputs to generate a third set of outputs. The method further includes processing, by a multilayer perceptron (MLP) block, the third set of outputs to generate a set of feature outputs, each feature output of the set of feature outputs representing a learned feature associated with an output of the third set of outputs.

According to embodiments, a method is provided for concurrently processing a plurality of sequences of varying lengths at a layer of a model during inference, according to an embodiment. The method includes grouping the plurality of sequences into a plurality of partitions such that padding required to balance the lengths of the plurality of partitions is less than padding required to balance the lengths of the plurality of sequences. The method further includes modifying one or more attention masks for each partition of the plurality of partitions to prevent tokens from different sequences within each partition from attending to one another during attention computation.

According to embodiments, another method is provided for concurrently processing a plurality of sequences of varying lengths at a layer of a model during inference. The method includes grouping the plurality of sequences into a plurality of partitions such that padding required to balance the lengths of the plurality of partitions is less than padding required to balance the lengths of the plurality of sequences. The method further includes processing the plurality of sequences by applying one or more attention masks to each partition of the plurality of partitions.

Efficient inference may be a relevant consideration for LLMs, particularly as these models scale to billions of parameters. Transformer architectures, which form the backbone of LLMs, may encounter various challenges that impact their efficiency during training and inference.

Transformers rely on a self-attention mechanism to compute relationships between all pairs of tokens in an input sequence. This computation scales quadratically with the sequence length (O(n²)), where n is the number of tokens. This quadratic complexity may pose a potential bottleneck in terms of memory and computation, particularly for longer sequences.

Current transformer-based models generally treat all tokens equally during sequence processing. For example, every token may pass through every layer with the same level of computational resources allocated to each one. This “one-size-fits-all” approach may lead to inefficiencies in certain context. For example, not all tokens contribute equally to the model's output as some tokens may be more important than others. Processing less important tokens with the same computational effort as important ones may lead to wasted resources and increased inference latency.

Transformer layers, which may include self-attention and feed-forward mechanisms, may be both memory- and computation-intensive. Allocating similar or identical resources to all tokens may result in increased floating point operations (FLOPs), which may lead to higher energy consumption. Allocating similar resources to all tokens may further result in slower sequence generation speeds, especially for autoregressive decoding tasks. Further, allocating similar resources to all tokens may result in reduced hardware efficiency due to uniform computation requirement.

Knowledge distillation (KD) refers to a technique that may be used to transfer knowledge from a large, complex model (referred to as the “teacher”) to a smaller, potentially more efficient model (referred to as the “student”). The process may involve training the student model to mimic or approximate the behavior of the teacher model by learning from its predictions, often using soft labels (e.g., probability distributions) rather than hard labels (e.g., ground truth). This technique may enable the student model to achieve performance comparable to the teacher model while being faster and more lightweight for deployment.

An existing technique is the mixture of depth (MoD), which dynamically allocates different amounts of computation to tokens in a sequence, based on their importance or complexity. In MoD, not all tokens in a sequence require the same amount of processing at each layer. Some tokens are relatively simple and can be processed through fewer layers, while more complex or critical tokens require deeper processing. In MoD, the model evaluates each token's importance, and based on this evaluation, it routes the token through a specific number of layers. Some tokens may bypass certain layers, while others might pass through the full depth of the network. By routing tokens with lower importance through fewer layers, MoD reduces the total number of operations for these tokens, thus lowering the overall computational burden (e.g., number of FLOPs).

Another existing approach is the adaptive early exit, which involves processing tokens through fewer layers in the transformer model and terminating their processing early if they have already reached a sufficiently confident prediction. This technique is based on the idea that not all tokens may require full processing to reach a reasonably accurate result, and some tokens can exit the model early. In adaptive early exist, during the processing of a token, the model evaluates whether it has achieved enough information to make a reliable prediction. If the confidence in the token's prediction is high, the token can “exit” early from the model, bypassing the remaining layers. The decision to exit early is typically based on a learned criterion, which could be a threshold on the prediction confidence or another performance measure. For example, a token might be classified as sufficiently processed once its likelihood score reaches a certain threshold, allowing it to bypass the final layers of the network.

Another existing approach is CoLT5, which is based on a transformer model tailored for long-sequence processing by employing conditional computation. CoLT5 allocates more resources to important tokens while processing less critical tokens with fewer computational overheads. The model builds on LongT5 model and introduces a mechanism where both the feedforward and attention layers are divided into a light branch and a heavy branch. The light branch processes all tokens with lower computational complexity, while the heavy branch is reserved for a subset of important tokens that are routed through based on their relevance. This routing is done via a learnable scoring function that assigns importance scores to tokens, allowing the model to apply computationally intensive operations where necessary. Additionally, CoLT5 uses multi-query attention (MQA), which may reduce the overhead in cross-attention layers by sharing keys and values across multiple attention heads.

Both MoD and adaptive early exit techniques involve dynamic routing or early termination based on token importance, which can lead to suboptimal processing for certain tokens. In MoD, layer skipping or assigning fewer layers to tokens may cause the model to miss important contextual information, especially for tokens that are important but do not meet the criteria for intensive processing. Similarly, in adaptive early exit, prematurely exiting tokens can result in a loss of important context, especially for tokens with complex dependencies. These mechanisms can lead to a reduction in the model's ability to generalize well to unseen data, particularly when tokens with crucial information are routed through fewer layers or exit too early.

A potential disadvantage of CoLT5 is using two quadratic pathways (light and heavy branches) for processing tokens. Thus, even though the light branch is less resource-intensive compared to the heavy branch, both branches have quadratic computational complexity. Further, CoLT5 processes tokens in both light and heavy branches within the same layer, which may reduce modularity and parallelism.

Another disadvantage of CoLT5 is applying a fixed token allocation for its heavy transformer block. The router in CoLT5 selects a predefined percentage of tokens (e.g., determined by the capacity hyperparameter) for processing in the heavy branch, regardless of the specific input batch.

A common limitation of existing techniques (e.g., MoD, adaptive early exit, and CoLT5) may be the inability to efficiently support batch inference. In these methods, the routing decisions are dynamically computed based on the individual characteristics of each token. Since the length and routing of tokens can vary from sequence to sequence, the lack of uniformity may pose challenges to process multiple sequences in parallel within a batch during the inference time. Padding sequences to make them uniform may negate the computational benefits of these techniques, which may reduce the performance gains. As a result, these methods may struggle to scale effectively for batch inference, which may be a relevant consideration for high-throughput applications in production settings.

Some embodiments may alleviate the growing computational challenges in deploying LLMs, particularly in scenarios where both performance and efficiency may be relevant. While traditional transformer architectures demonstrate acceptable generalization and adaptability across various tasks, these traditional architectures may incur computational and energy costs. Some embodiments provide an architecture that may retain the generalization performance of a full transformer model while achieving potential gains in computational efficiency.

Traditional transformer models uniformly allocate computational resources to all tokens, regardless of their importance in the context of a task. This approach may be inefficient, as certain tokens contribute more significantly to the output, while others have minimal impact. Some embodiments provide for a dynamic routing mechanism that may distinguish between important and less important tokens and allocate more computational resources to the former and lightweight processing to the latter. This adaptive approach may improve resource utilization without compromising the model's accuracy.

Transformer models, particularly in high-dimensional tasks, may require substantial floating-point computations, making them computationally expensive. According to embodiments, a framework or architecture is provided that may reduce the number of FLOPs by introducing lightweight components, such as adaptor blocks, for less critical tokens while maintaining high-fidelity computations for important tokens. This hierarchical processing strategy may lower the computational burden, enabling the model to operate efficiently.

The high computational complexity of transformer models often results in slow training and inference times, limiting their scalability for real-world applications. Some embodiments may provide for an improved model architecture which may involve sub-quadratic processing for less important tokens and efficient token routing mechanisms, which may accelerate both training and inference.

Large-scale deployment of LLMs often involves batch inference scenarios, where the model processes multiple input sequences concurrently. Present methods like MoD and adaptive early exit may not adequately support batch inference. According to embodiments, a model architecture is provided that may improve batch inference through leveraging the packing mechanism and balanced partitioning of the tokens.

Energy efficiency may be a relevant consideration in deploying LLMs, especially in edge devices and large-scale server environments. Power consumption of traditional transformers may result from their compute-intensive attention and feedforward layers. Embodiments can minimize power consumption by introducing lightweight layers (e.g., adaptor layers and mamba layers) and dynamically adjusting computational requirements based on token importance. This adaptive approach may ensure energy-efficient processing while maintaining performance.

Some embodiments may combine a quadratic heavy pathway for important tokens with a sub-quadratic lighter pathway for less important tokens. This architectural design may lead to improved overall efficiency, as less computationally important tokens are processed with reduced complexity.

Some embodiments may provide for an improved architecture in terms of modularity and parallelism. In some embodiments, tokens are routed to either the quadratic or sub-quadratic block, which operate in parallel. This parallel design may improve token processing based on their importance. The separation of computational pathways, in one or more embodiments, may allow for better scaling and improved efficiency.

Some embodiments may allow for an improved token allocation. Some embodiments may allow for a flexible and adaptive token allocation. According to some embodiments, tokens are allocated dynamically to the heavy or light pathways based on the importance or significance scores for each batch in each layer. This dynamic allocation may result in improved use of computational resources, adjusting to the needs of each input batch.

Traditional transformer-based models typically process all tokens in an input sequence with equal computational effort, regardless of their importance. This may result in wasted computational and memory resources, as not all tokens require the same level of processing in every layer.

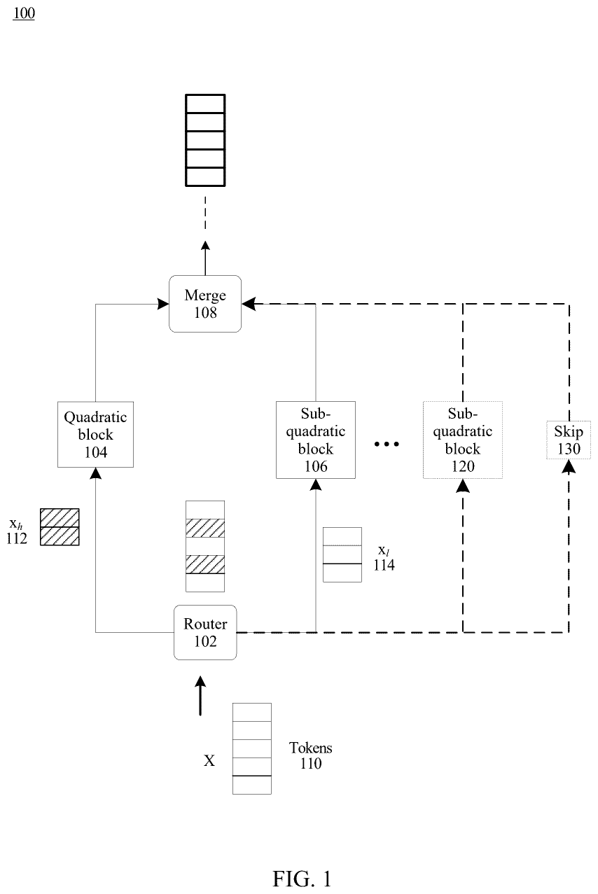

According to an embodiment, dynamic token routing network (DTRNet) is provided. DTRNet may dynamically allocate computational resources based on the importance of each token. FIG. 1 illustrates a dynamic token routing network (DTRNet) layer, according to an embodiment. In some embodiments, the DTRNet layer 100 may refer to an architecture or framework of a layer of a transformer-based model. According to an embodiment, a layer 100 of DTRNet includes at least one of: a router 102, a quadratic block 104, a sub-quadratic block 106 and a merge or merging function (or block) 108. The router 102 may serve as a dynamic routing mechanism. According to an embodiment, the router 102 evaluates (or is configured to evaluate) the embeddings of tokens 110 and assigns an importance or significance score to each one. In some embodiments, tokens with higher importance or high priority tokens, xₕ, 112 are routed to the quadratic block 104, while less critical tokens or low priority tokens, xₗ, 114 are sent to the sub-quadratic block 106.

In some embodiments, the quadratic block 104 handles the important tokens using transformer mechanisms. In some embodiments, the quadratic block 104 includes one or more of: an attention block and a multilayer perceptron (MLP) block. The attention block may be responsible for processing token relationships. The MLP block may feature extraction capabilities.

In some embodiments, the sub-quadratic block 106 may be designed for improved processing of less critical tokens. The sub-quadratic block 106 may reduce computational complexity. In some embodiments, the sub-quadratic block 106 is a linear token processor. In some embodiments, the sub-quadratic block 106 is implemented as an MLP adaptor block or a mamba token mixer block.

In some embodiments, the architecture 100 may include additional sub-quadratic blocks 120 to which the router 102 may dynamically route tokens. In some embodiments, the router may router tokens directly to the merge block 108 through the skip block 130.

In some embodiments, each transformer layer is augmented with one or more computational blocks (e.g., adaptor block or mamba token mixer block) that process tokens not requiring the full complexity of the transformer's attention mechanism. This can allow the model to adaptively allocate resources while maintaining performance.

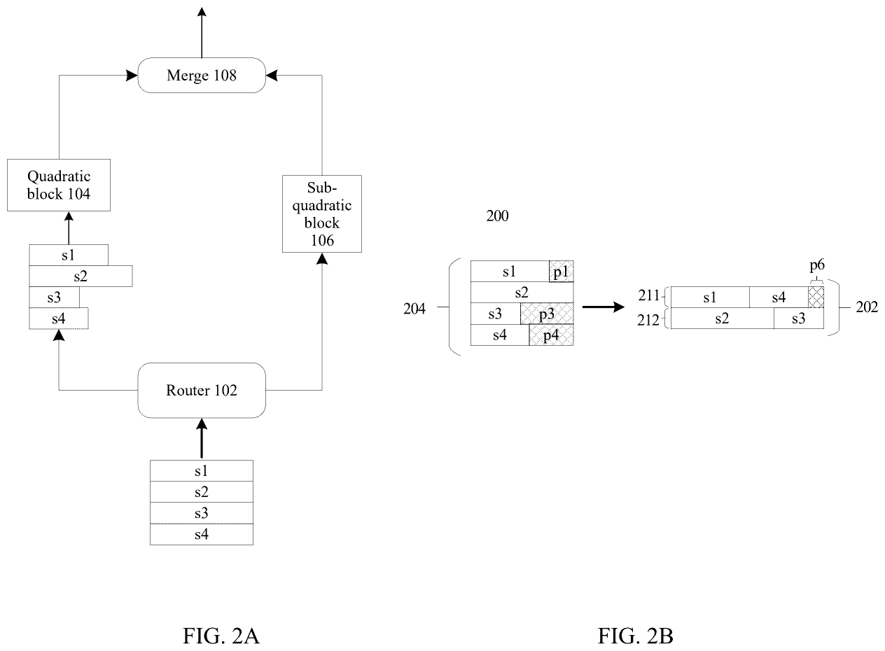

FIGS. 2A and 2B illustrate a batch inference approach, according to an embodiment. In some embodiments, the batch inference approach may be used for autoregressive generation.

Dynamic token routing may introduce challenges during batch inference, as tokens routed to different blocks may result in sequences of varying lengths. FIG. 2 illustrates the challenges associated with padding during batch inference. As shown in FIG. 2A, input sequences s1, s2, s3 and s4 have been routed to the quadratic block 104, where the sequences differ in length, with s2 representing the longest sequence. When sequences of varying lengths are processed together, padding is traditionally applied to align their lengths to the longest sequence in the batch (e.g., s2). However, padding these sequences to the longest length may negate the computational benefits, as the padded batch would require processing all tokens equally.

While tokens deemed important or high priority are sent to the transformer block, the presence of varying sequence lengths may require padding to align token dimensions for processing. This padding may increase computational overhead and undermines the potential efficiency gains which may be achieved by selectively routing tokens based on their importance. The merge function 108 may combine token outputs after processing, but the padded tokens may add unnecessary computational burden, even though they may not contribute meaningfully to the model's output.

According to some embodiments, FIG. 2B illustrates packing and balanced partitioning of sequences, according to an embodiment. In some embodiments, a method 200 may be used for enabling batch inference during autoregressive generation by employing packing and balanced partitioning of sequences. In some embodiments, tokens from multiple sequences (e.g., sequences s1, s2, s3, and s4) are packed or organized into multiple partitions 202. The partitions are arranged such that the sequence lengths are balanced or adequately balanced across the partitions, minimizing the amount of padding (indicated by cross hatching) required. For example, partitions 202 illustrated in FIG. 2B includes tokens from sequences s1, s2, s3, and s4 organized to minimize padding. As shown, the padding needed for balancing partitions 202 is less than the padding required for balancing the sequences 204.

In some embodiments, the plurality of sequences 204 is grouped into the plurality of partitions 202 to reduce the padding required to balance the lengths of the plurality of partitions compared to the padding required to balance the lengths of the plurality of sequences. For example, balancing the lengths of the plurality of sequences 204 (e.g., s1, s2, s3 and s4) requires a total padding amount of Padding_sequences=p1+p3+p4. Whereas, balancing the lengths of the plurality of partitions 202 requires a total padding amount of Padding_partitions=p6, where Padding_partitions is less than Padding_sequences. Accordingly, grouping the plurality of sequences 204 into the plurality of partitions 202 results in the plurality of partitions 202 requiring less padding (e.g., p6) to balance (or equalize) their lengths than the padding required (e.g., p1+p3+p4) to balance the lengths of the plurality of sequences 204.

By balancing the partitions, the amount of computational overhead caused by padding may be reduced, while preserving the computational benefits provided by dynamic routing mechanisms.

In some embodiments, after packing, customized attention masks may be applied to ensure that tokens from different sequences within the same partition remain independent. In some embodiments, attention masks may be modified to ensure that tokens from different sequences in a batch do not attend to one another. The modified attention masks may prevent tokens from one sequence (e.g., s1) from attending to tokens belonging to another sequence (e.g., s2, s3, s4). For example, a modified attention mask associated with the first partition 211 may prevent tokens from s1 from attending to tokens from s4, and vice versa. Similarly, a modified attention mask associated with the second partition 212 may prevent tokens from s2 from attending to tokens from s3, and vice versa.

This may maintain the independence of each sequence while improving computation. In some embodiments, by using modified attention masks, the independence of each sequence during autoregressive generation may be maintained, even when multiple sequences share a partition.

Embodiments may enable batch inference that could be computationally efficient and scalable by leveraging one or more of token packing, balanced partitioning, and attention masking techniques. Some embodiments may facilitate real-time, large-scale deployment for autoregressive tasks without sacrificing the benefits of dynamic token routing.

According to some embodiments, a system or a model based on DTRNet is provided. The model includes multiple layers in a deep neural network (DNN), where each layer or each DTRNet layer includes one or more of: a router 102 for token selection, a quadratic block 104 for high-priority token processing, a sub-quadratic block 106 for low-priority (or lower-priority) token processing, and a merge or merging function 108 to integrate the outputs.

In some embodiments, the router 102 may apply dynamic token selection and regularization as described herein. In some embodiments, each layer of the DTRNet incorporates a router 102 implemented as a multilayer perceptron (MLP) neural network. In some embodiments, the MLP neural network includes one or more layers. In some embodiments, the router 102 is designed to manage computational resources by dynamically selecting tokens for processing. In some embodiments, the MLP neural network includes a sigmoid activation function applied to the output of a final layer. In some embodiments, a function of the router is to assign a numerical score between 0 and 1 to each token embedding in the input sequence, where the score reflects the computational priority of the token. In some embodiments, higher scores correspond to tokens that require more computational resources, while lower scores indicate tokens with lesser computational demands.

In some embodiments, during the training phase, the weights of the MLP are updated to allow the router to learn how to assign these scores based on the computational requirements of each token. Once the tokens in a given batch are scored, in some embodiments, the router 102 determines which tokens should be routed to the quadratic block 104 and which should be sent to the sub-quadratic block 106. In some embodiments, the router 102 identifies and/or selects a first set of high-priority tokens and a second set of low-priority tokens based on scores and applicable thresholds. In some embodiments, the router 102 determines the appropriate processing path or routing destination for different sets of tokens based on the embodiment being employed.

In some embodiments, the router 102 includes a scoring component (e.g., the MLP neural network) configured to assign an importance score to each input token. In some embodiments, the router 102 further includes a selection mechanism configured to select tokens for routing based on these assigned scores. In some embodiments, the scoring component (e.g., the linear network or MLP) operates to produce importance scores without direct awareness of parameters governing the subsequent selection step, such as a target number or proportion ‘k’. The selection mechanism then utilizes these scores to implement a specific routing strategy.

In some embodiments, a ‘top-k’ routing strategy may be employed. In this strategy, ‘k’ may be a predefined hyperparameter representing a predetermined number or portion of tokens to be selected. The selection mechanism may identify the ‘top-k’ tokens based on the highest scores assigned by the scoring component. For instance, if the hyperparameter ‘k’ is set to represent 20% of the tokens in a sequence, the selection mechanism selects the 20% of tokens with the highest importance scores. These selected tokens (forming a first set) are designated for high-priority processing (e.g., routed to the quadratic block 104), while the remaining tokens (forming a second set) are designated for low-priority processing (e.g., routed to the sub-quadratic block 106). The combined operation of scoring and selection based on a fixed hyperparameter ‘k’ may constitute the ‘top-k’ routing process in these embodiments.

In other embodiments, a dynamic routing strategy, sometimes referred to as ‘top-max-k’, may be employed to adapt the selection based on token scores while managing computational load. In this approach, the selection mechanism may initially identify tokens based on whether their assigned importance score exceeds a predetermined priority threshold (e.g., a score greater than 0.5). A potential challenge with solely using a score threshold is that it can lead to a variable number of selected high-priority tokens across different sequences within the same batch, which may complicate batched processing architectures requiring uniform input shapes.

To address potential variability in the number of selected tokens per sequence while still allowing for score-based dynamic selection, some embodiments implement a batch-aware selection process. In such embodiments, after identifying tokens exceeding the priority threshold in each sequence, the selection mechanism determines a dynamic batch value, denoted as ‘k’, which represents the maximum number of such high-priority tokens found in any single sequence within the current batch. This dynamic value ‘k’ may then used as a basis for selecting tokens from all sequences in the batch, which may ensure uniformity for batched computation, as described herein.

In some embodiments, for example those employing a dynamic selection strategy, to ensure a controlled allocation of tokens for high-intensity processing (typically within the quadratic block 104 or an attention block), a threshold-based mechanism incorporating an upper limit is used. In some embodiments, a parameter, for example, an upper threshold or max_k, is defined, representing a maximum number of tokens from each sequence that, in some embodiments, can be sent or routed to the quadratic block 104. In some embodiments, the upper threshold, max_k, may represent a maximum number of tokens from each sequence that can be part of the first set of input tokens (i.e., designated or identified as high-priority) Thus, max_k may be a maximum allowable number of high-priority tokens per sequence (which may correspond to the ‘top_max_k’ hyperparameter). In some embodiments, for each sequence in a batch, the router 102 initially evaluates the embedding of each token and assigns an importance score (as performed by the scoring component). In some embodiments, the router 102 (via for example, the selection mechanism) then counts the number of tokens in each sequence with a higher computation priority based on the token score and a priority threshold. For example, a priority threshold may be set to 0.5 and a score greater than 0.5 may be considered a higher computational priority or a higher priority token. The router selects the maximum number of such high-priority tokens across the entire batch and labels this value as k. In some embodiments, k may represent the maximum number of high-priority tokens across the sequences in the entire batch. In some embodiments, a dynamic batch threshold may refer to a maximum amount of high-priority tokens in any one sequence of the one or more sequences. In some embodiments, each of the upper threshold (max_k) and the dynamic batch threshold (k) is a number, a portion or a representation of a threshold or limit.

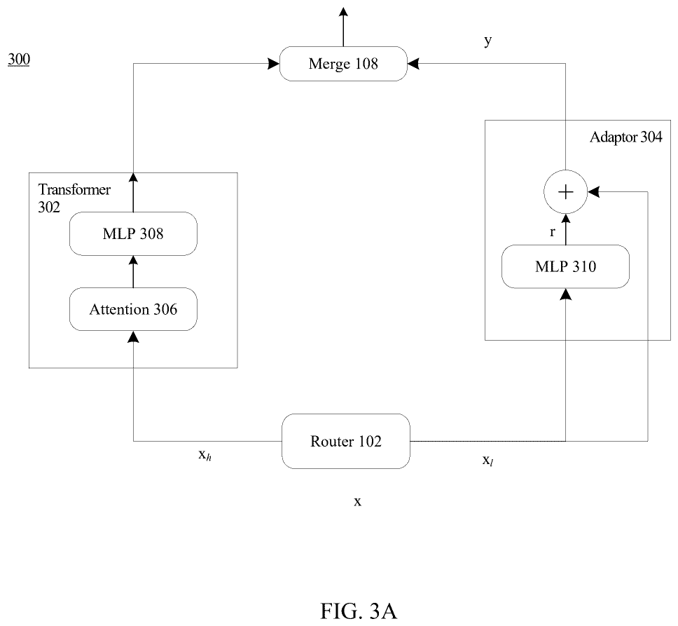

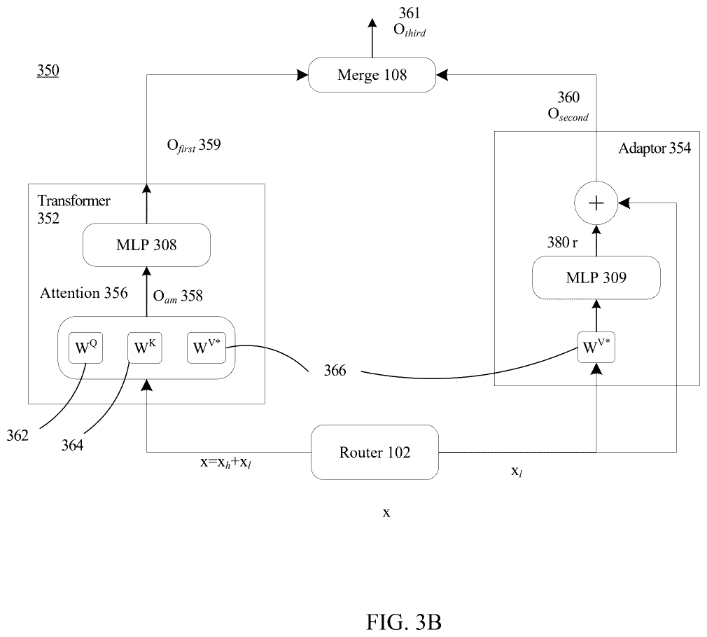

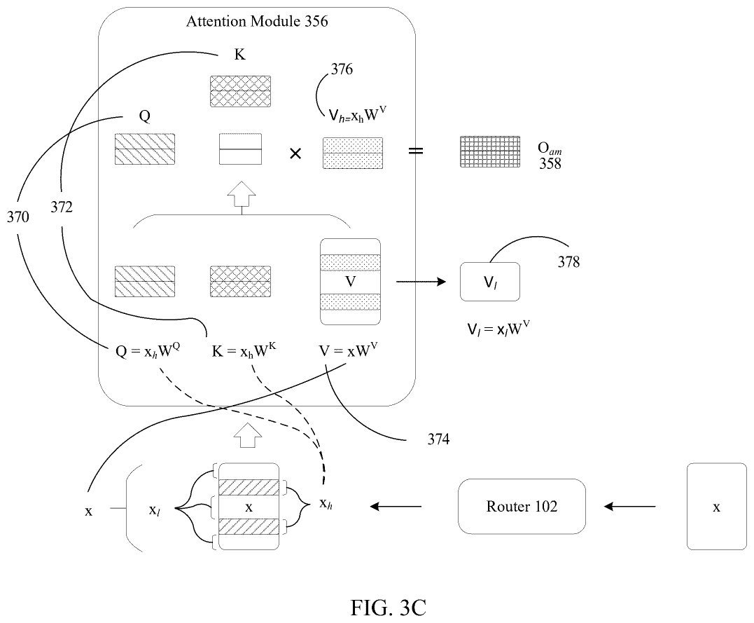

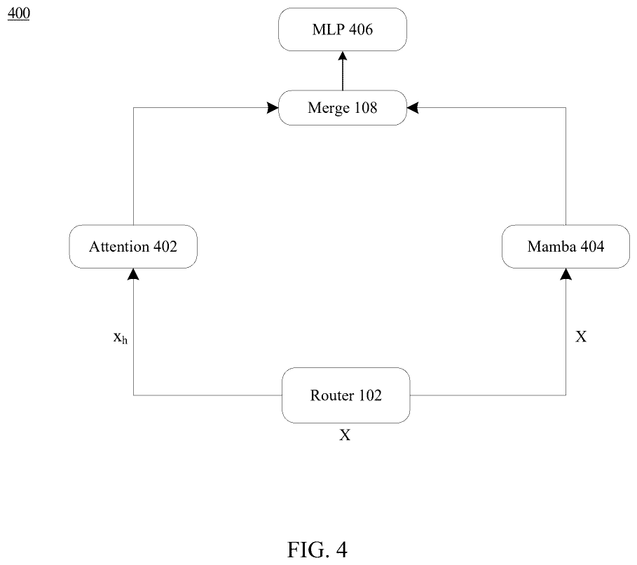

In some embodiments, the number of high-priority tokens selected and/or identified for the first set (or to be sent to the quadratic block) from each sequence is determined based on comparing k (e.g., dynamic batch threshold) and maxₖ (e.g., upper threshold). In some embodiments, if k (e.g., dynamic batch threshold) is less than or equal to maxₖ (e.g., upper threshold), the router selects and/or identifies the top k tokens (e.g., those with the highest scores) from each sequence in the batch that forms part of the first set (and/or to be sent to the quadratic block). In some embodiments, if k exceeds max_k, the router selects only the top max_k tokens (e.g., capped at the upper threshold) from each sequence to form part of the first set and/or send them to the quadratic block 104. The routing of these identified sets may depend on the architecture. In some embodiments, the first set of tokens (high-priority) is routed to the quadratic block (104 or 302), and the second set of tokens (low-priority) is routed to the sub-quadratic block (106 or 304) as described in reference to FIG. 1 and FIG. 3A. In other embodiments, for example, in reference to FIGS. 3B and 3C, the second set of tokens (low-priority) may be routed to the sub-quadratic block (354), while the complete set of input tokens (x), along with an indication of the identity of the first set (e.g., indication within that complete set) is routed to the quadratic block (352) to enable differential processing therein. In further embodiments, such as the DTRNet-mamba architecture 400 of FIG. 4, the first set of tokens (xₕ, high-priority) may be routed to a quadratic block such as an attention block 402, while the complete set or all of input tokens (x, comprising both first and second sets) is routed to the sub-quadratic block (e.g., Mamba block 404). This dynamic token routing mechanism may ensure that tokens are directed to appropriate processing paths based on their priority and the layer architecture, while the maxₖ threshold may control the maximum computational load for the high-intensity path.

In some embodiments, the remaining tokens that do not meet these thresholds are routed to the sub-quadratic block 106. For example, the number of remaining tokens in a sequence may be determined as the total tokens in a sequence minus the number of tokens selected for the quadratic block 104. In some embodiments, the number of tokens selected for the quadratic block may correspond to k (if k≤max_k) or max_k (if k>max_k). This dynamic token selection mechanism may ensure that the number of tokens processed by the quadratic block 104 is adaptively adjusted based on the specific input batch in each DTRNet layer, while preventing the number of selected tokens from exceeding the pre-defined maxₖ.

In some embodiments, to encourage the routers in each DTRNet layer to select fewer tokens for high-priority processing, a regularization term is added to the network's loss function during training. This regularizer may penalize the router for selecting too many tokens with high scores, which may promote efficiency in token selection.

Consider a DTRNet network with L layers, where the input batch includes m sequences, each with a maximum sequence length of n. The output of the router for each sequence may be represented by a vector g, where each element is a score between 0 and 1. In some embodiments, the regularization term added to the loss function is as follows:

$${\sum }_{i = 1}^{L} {\sum }_{j = 1}^{m} {‖ {\vec{g}}_{ij} ‖}_{2}^{2} ,$$

Where \vec{g}ᵢⱼ is the output score vector for the i-th DTRNet layer (where i=1 to L) and the j-th sequence (j=1 to m) in the batch, and

$${‖ \cdot ‖}_{2}^{2}$$

denotes the squared L2 norm of the score vector, which penalizes the router for assigning high scores to too many tokens. The vector \vec{g}ᵢⱼ may include or be based on elements (e.g., token scores) between 0 and 1, where each element corresponds to a token's priority score for routing. Higher scores (e.g., closer to 1) may indicate a higher computational priority, meaning the token is more likely to be sent to the quadratic block.

This regularization term may reduce the tendency of the network to route excessive tokens to the quadratic block, thereby controlling the computational load and enhancing processing efficiency.

In some embodiments, the regularization term is added to the final loss function of the DTRNet to obtain an updated loss function as follows:

$${L}_{new} = {L}_{orig} + λ {\sum }_{i = 1}^{L} {\sum }_{j = 1}^{m} {‖ {\vec{g}}_{ij} ‖}_{2}^{2}$$

Where, L_{new} is the updated loss function, and L_{orig} is the original loss function of the neural network, which may typically be cross-entropy loss in the context of LLMs. The hyperparameter, A, is a scalar coefficient that controls the impact of the regularizer (e.g., regularization term) on the overall loss function. A higher λ may impose a stronger penalty, encouraging the router to be more conservative in selecting high-priority tokens.

By introducing the regularization term, computational resources may be better used, as the router learns to assign fewer tokens to the quadratic block without compromising the performance of the model. This strategy may improve overall efficiency of the DTRNet architecture during both training and inference phases, as the network may avoid excessive routing, controlling the computational load.

In some embodiments, the routing process during inference uses scores assigned by the pre-trained router 102 to select tokens for different processing paths, where the selection mechanism can be configured in various ways and may potentially be streamlined to improve efficiency. For example, in some embodiments, for each token, the system evaluates the score assigned by the router against a priority threshold (e.g., 0.5). If the token's score exceeds the priority threshold, the token is identified and/or selected as belonging to the first set (high-priority) and directed for corresponding processing (e.g., routed to the quadratic block or attention block or processed accordingly within the quadratic block, depending on the embodiment). Conversely, if the score is equal to or below the priority threshold, the token is identified and/or selected as belonging to the second set (low-priority) and directed for corresponding processing (e.g., routed to the sub-quadratic block, or processed by the sub-quadratic block which might receive all tokens in some embodiments like FIG. 4). Alternatively, or in addition, in some embodiments, the selection process during inference may involve identifying a ‘top-k’ set of tokens based on ranking the importance scores assigned by the pre-trained router. This could involve selecting the ‘k’ tokens with the highest scores overall, or potentially selecting the ‘k’ highest-scoring tokens from among those that meet a certain criteria, such as exceeding the priority threshold mentioned above. The value of ‘k’ for inference may be a predetermined number or portion. Based on the employed selection logic (which may involve thresholding, top-k score ranking, or a combination thereof), tokens identified as high-priority (first set) are directed for corresponding processing (e.g., related to the quadratic block path), while the remaining tokens (second set) are directed for other processing (e.g., related to the sub-quadratic block path). This streamlined decision-making process may enable more efficient allocation of computational resources based on real-time token scores during inference.

According to some embodiments, the quadratic block 104 refers to a transformer block characterized by quadratic computational complexity with respect to the number of tokens it processes. The term “quadratic” may indicate that the computational cost of processing the tokens scales with the square of the number of tokens. This behavior is typical of standard transformer architectures, where the self-attention mechanism computes attention weights for each token in relation to all other tokens, resulting in quadratic complexity. In some embodiments, the quadratic block is a standard attention block.

In some embodiments, the quadratic block 104 is configured to process a subset of tokens, for example, top-k or top-max_k tokens as the case may be, which are selected by the router based on their importance or need for greater computational resources. Once the top-k or top-max_k tokens are identified and routed, the quadratic block 104 processes these tokens to generate corresponding processed embeddings. The quadratic block performs detailed or intensive computations on the high-priority tokens, allowing the model to focus or limit computational resources on the critical parts of the input sequence.

In some embodiments, the quadratic block 104 employs standard transformer operations, such as multi-head self-attention and feed-forward layers. In some embodiments, these transformer operations are reserved for a smaller, computationally expensive subset of tokens. By processing a reduced number of tokens in the quadratic block, the DTRNet may concentrate its computational resources where they are most needed, while potentially maintaining overall efficiency.

By limiting the use of quadratic operations to a selected portion of the tokens, the system may improve performance. For example, computationally intensive operations may be applied where they provide a potential benefit, while lower-priority tokens may be processed using less costly methods. This selective allocation of resources may help mitigate the high computational demands traditionally associated with transformer models, thereby potentially enhancing scalability and performance for large-scale inputs.

According to some embodiments, the sub-quadratic block 106 is responsible for processing tokens that are assigned lower computational priority by the router. In contrast to the quadratic block, which processes high-priority tokens using computationally expensive operations, the sub-quadratic block operates with sub-quadratic or linear computational complexity to handle lower-priority tokens more efficiently. In some embodiments, the sub-quadratic block is a lighter token-processing block.

In some embodiments, the term “sub-quadratic” refers to processing methods whose computational cost grows at a rate lower than quadratic with respect to the number of tokens. In some embodiments, the sub-quadratic block implements various token processing methods, including linear attention models or simpler approaches such as a multilayer perceptron (MLP) block. For example, linear attention models may reduce the complexity of the standard self-attention mechanism by approximating the attention weights in a manner that scales linearly with the number of tokens, offering a potentially computationally efficient alternative to the standard self-attention mechanism for processing lower-priority tokens.

In some embodiments, the sub-quadratic block processes tokens that are not selected as top-k or top-max_k by the router (e.g., tokens other than selected high priority tokens). These tokens, which are assigned a lower computational priority, are typically deemed less critical to the overall decision-making process of the model and may require fewer computational resources compared to the higher priority tokens. By processing lower computational priority (or lower priority or low priority) tokens using methods with sub-quadratic complexity, embodiments handle these tokens appropriately while minimizing unnecessary computational overhead.

The architectural design including the sub-quadratic block may allow the DTRNet system to scale efficiently by reserving computationally intensive operations for important (high priority) tokens in the quadratic block 104, while processing the remaining tokens in the sub-quadratic block 106. In some embodiments, the design of the sub-quadratic block may allow for the integration of any sub-quadratic processing method, thereby potentially enabling adaptability in balancing computational efficiency and model performance. This approach may further improve allocation of resources across the entire token set, contributing to the scalability and efficiency of the system.

According to some embodiments, the merge or merging function 108 is responsible for recombining the processed embeddings of tokens that were previously routed through the quadratic block 104 and the sub-quadratic block 106. This merging function may ensure that, after tokens are processed separately based on computational priority, their embeddings are re-arranged into their original positions within the sequence before being passed to the next layer of the model. In some embodiments, once the tokens are processed (by the quadratic and sub-quadratic blocks), the merge function combines the output embeddings from both mixers or blocks into a single tensor.

In some embodiments, the merging function 108 operates by receiving two sets of processed embeddings: a first set corresponding to high-priority tokens processed by the quadratic block, and a second set corresponding to lower-priority tokens processed by the sub-quadratic block.

In some embodiments, these two sets of embeddings are initially split from the original sequence of input tokens based on routing decisions made by the router 102. In some embodiments, to maintain the integrity of the token sequence, the merging function repositions each token embedding into its correct, pre-split location, which may effectively reconstruct the original token order.

This re-arrangement process may be relevant for preserving the structure of the token sequence as the embeddings are passed through subsequent layers of the model. Without proper reordering, the model could lose track of the relationships between tokens, potentially leading to incorrect outputs. By ensuring that each token's processed embedding is returned to its original position, the merging function may increase the likelihood that the positional context of the tokens is preserved, enabling the model to continue processing the tokens correctly in future layers.

In some embodiments, the merging function may preserve token order. In some embodiments, the system via the merging function may improve interoperability between different blocks within the DTRNet system, regardless of their computational complexity. By unifying the outputs of the quadratic and sub-quadratic blocks into a consistent format for the next stage of processing, the merging function may enable the system to balance high- and low-priority processing while maintaining accuracy and coherence in subsequent layers.

Traditional approaches to dynamic routing encounter difficulties during batch inference due to the variability in the number of tokens selected for processing across different sequences in the batch. For example, after passing through the router, the number of tokens selected for processing may differ between sequences, leading to inconsistencies in token lengths, as described in reference to FIG. 2A.

This variability may present a challenge because padding the sequences 204 to ensure uniform lengths would potentially negate the efficiency benefits of dynamic routing. The computational cost of processing a padded batch would approach that of processing all tokens, thereby undermining the advantages of dynamic routing and limiting its ability to improve performance.

In some embodiment, the system performs batch inference using input-dependent dynamic routing methods. To overcome the challenge of adequately performing batch inference, in some embodiments, the system employs a method 200 that leverages packing and balanced partitioning to perform batch inference with reduced reliance on padding. In some embodiments, instead of padding the sequences in the batch, the system groups the sequences into a set of partitions 202, ensuring that the lengths of each partition 211 and 212 are as balanced as possible. In some embodiment, balanced partitioning includes ensuring that the total number of tokens across each partition is approximately equal. Thus, the system may ensure that the partitions themselves (as groups of sequences) are approximately equal in length, which may minimize the amount of padding required to make partitions uniform for batch processing.

This balanced partitioning may be a relevant consideration, as it may reduce or minimize the number of padding tokens needed, thereby potentially reducing the computational overhead of processing the batch.

In some embodiments, once the sequences are packed into balanced partitions, the system modifies the attention masks within or for each partition to prevent sequences from attending to one another. In some embodiments, the system, via the modified attention masks, may prevent sequences within each partition from interacting with one another during self-attention process. Thus, tokens from one sequence may not consider tokens from another sequence during the self-attention process. The modification of attentions masks may prevent interference between sequences, while potentially maintaining the efficiency of the transformer's attention mechanism, as only the relevant tokens within each sequence are attended to.

In some embodiment, by restricting the self-attention mechanism to operate within individual sequences, the system may ensure that each sequence is processed independently, thereby preserving the intended structure and context of each sequence. This adjustment may maintain the efficiency of the self-attention mechanism while avoiding unnecessary computational costs associated with processing inter-sequence interactions.

In some embodiments, the system organizes sequences into a fixed number of partitions to balance the partitions and reduce the amount of padding required. An objective of balanced partitioning may be to ensure near-equal lengths across sequences in each partition of a batch for evaluation.

In some embodiments, balancing the partitions or balanced partitioning includes using a first-fit approach to assign sequences to partitions. This approach may operate with a time complexity of O(n log n), where n represents the number of sequences. In some embodiments, according to the first-fit approach, each sequence is assigned to a first available partition that can accommodate its length.

In some embodiments, balanced partitioning includes using a best-fit approach to place a sequence in a partition. In some embodiments, the best-fit approach has a time complexity of O(n log n). In some embodiments, according to the best-fit approach, each sequence is placed or assigned to a partition that results in the least additional padding, thereby reducing imbalance across partitions.

In some embodiments, balanced partitioning includes a Polynomial-Time Approximation Scheme (PTAS). This approach may allow for a trade-off between computational complexity and the optimality of the partitioning solution. In some embodiments, the time complexity of the PTAS approach is O(f(1/ϵ)·p(n)), where ϵ is a user-defined parameter controlling the trade-off between optimality and computational complexity. The parameter E may control the balance between the quality of the partitioning and the associated computational cost. By adjusting E, the system can prioritize quality of partitioning or reduced processing time, depending on the requirements of the use case.

In some embodiments, the system may enable improved batch inference while reducing computational penalties associated with padding by employing one or more techniques, such as partition packing, balanced partitioning, and attention mask modification. These methods may help ensure that the benefits of input-dependent dynamic routing are preserved during large-scale model inference.

One or more embodiments may apply to products or systems that implement input-dependent dynamic routing and batch processing during inference. Such embodiments may include, but are not limited to, applications involving LLMs, transformer-based architectures, neural networks, and other machine learning models that utilize dynamic token processing based on computational priority. Embodiments may further apply to any products or systems that incorporate one or more of the following: a dynamic router for token selection, quadratic blocks for high-priority token processing, sub-quadratic blocks for lower-priority token processing, and techniques for efficient batch inference, such as packing, balanced partitioning, and attention mask modification.

Some embodiments may extend to systems designed for real-time inference or large-scale deployment, where minimizing computational overhead and optimizing resource allocation are relevant. These embodiments may be applicable to various domains, including natural language processing, computer vision, recommendation systems, and other fields requiring scalable, token-dependent processing frameworks.

According to an embodiment, based on the general DTRNet framework 100, a network architecture referred to as DTRNet-adaptor may be provided. FIG. 3A illustrates a DTRNet-adaptor layer, according to an embodiment. The DTRNet-adaptor layer or architecture 300 includes at least one of a router 102, a transformer 302 (similar to quadratic block 104), an adaptor 304 (e.g., similar to sub-quadratic block 106), and a merge or merging function 108.

In some embodiments, the DTRNet-adaptor includes one or more layers 300 for processing tokens by incorporating an adaptor module 304 (a sub-quadratic block) within the DTRNet layers. In some embodiments, the architecture 300 is designed to dynamically allocate computational resources based on token importance, ensuring potential improved performance while reducing computational overhead.

In some embodiments, the DTRNet layer 300 facilitates dynamic token processing based on computational priority. In some embodiments, the processing begins with the router 102, which is implemented as a feedforward neural network (e.g., an MLP). In some embodiments, the router 102 assigns importance scores to each input token and dynamically selects a parameter k (e.g., a dynamic batch threshold) and/or parameter max_k (e.g., an upper threshold), based on these scores. In some embodiments, the top-k or top-max_k tokens, representing those deemed high priority or relatively more important for the task, are routed to computationally intensive processing blocks (e.g., transformer 302). This selective routing may ensure that the important or high priority tokens undergo a high-level of processing, which may preserve task accuracy.

In some embodiments, during inference, the router 102 functions as a classifier, determining or identifying whether each token is classified as important (high priority), e.g., xₕ or less important (low priority), e.g., xₗ. This classification may enable efficient token routing by directing critical or important tokens to the appropriate processing path. As a result, inference may be accelerated while reducing potential compromises to model performance or accuracy.

In some embodiments, tokens classified as important or high priority, e.g., xₕ, by the router are sent to the quadratic transformer block 302. In some embodiments, the quadratic transformer block 302 includes one or more of self-attention layer or block 306 and MLP 308 components. In some embodiments, quadratic transformer block 302 processes the important0020tokens using an increased capability or full capabilities of the transformer architecture. The quadratic transformer block may preserve the model's ability to capture complex token interactions and dependencies, which may further ensure thorough processing of tokens that are critical for maintaining high performance.

In some embodiments, less important or low priority tokens, e.g., xₗ, as determined by the router, are routed to the adaptor block 304. In some embodiments, the adaptor block 304 is a lightweight module based on an MLP architecture, designed to reduce computational overhead. In some embodiments, instead of applying a full transformation, the adaptor block 304 modifies the less important tokens with a small perturbation, which may ensure their coherence with the overall token representations.

In some embodiments, the operation of the adaptor block 304 can be described mathematically as, y=xₗ+r, where y represents the output of the adaptor block 304, xₗ is the input token embedding, and r is a residual vector introduced by the MLP component 310. In some embodiments, the residual vector, r, slightly adjusts the token embeddings, which may maintain their relevance while reducing the computational cost associated with their processing. Thus, the MLP block processes information derived from the second set of tokens (in this case, the tokens themselves, xₗ) to generate adjustment values (in this case, the residual vector r). The sub-quadratic block (adaptor 304) then processes the second set of input tokens and the generated adjustment values (r) to produce the second set of outputs.

In some embodiments, once the tokens have been processed by the quadratic transformer block 302 and the adaptor block 304, their respective outputs are combined at the merge function 108. In some embodiments, the router scores are applied to these outputs through element-wise multiplication, which may ensure that the router's importance decisions are reflected in the final token representations. In some embodiments, these weighted outputs are then merged and passed to the next layer for further processing.

The integration of the router's output into the overall workflow of the DTRNet-adaptor layer may allow the router to be trained alongside the rest of the model, which may further contribute to the overall efficiency and performance of the DTRNet-adaptor.

The DTRNet architecture 300 may provide a flexible and computationally improved approach to token processing, balancing high-fidelity processing for important tokens with reduced computational costs for less critical tokens.

Referring now to FIG. 3B, an alternative embodiment of a DTRNet layer, referred to as a fused DTRNet-Adaptor layer 350, is illustrated. This embodiment may provide a parameter-efficient variant of the DTRNet-Adaptor layer 300 shown in FIG. 3A by sharing certain model weights between the quadratic processing block (transformer block 352) and the sub-quadratic processing block (adaptor block 354). This design may reduce the number of learnable parameters while preserving the adaptive token processing capability. The overall structure includes the router 102, transformer block 352 (similar to quadratic block 104), adaptor block 354 (e.g., similar to sub-quadratic block 106), and merge block 108 components.

According to an embodiment, the router 102 receives one or more sequences of input tokens, collectively denoted as x. In some embodiments, the router 102 assigns a score to each input token indicating its computational priority and identifies a first set of input tokens (xₕ) corresponding to high-priority tokens (e.g., those with scores exceeding a priority threshold) and a second set of input tokens (xₗ) corresponding to low-priority tokens. The complete set of input tokens x comprises both the first set xₕ and the second set xₗ. In some embodiments, the router 102 routes the second set of input tokens xₗ to the sub-quadratic processing block (adaptor 354). Furthermore, the router 102 routes the complete set of input tokens x (all input tokens of the received one or more sequences) to the quadratic processing block (transformer 352), wherein the identity of the first set of input tokens xₕ within the complete set x is made available to the quadratic processing block 352 (e.g., via indices or other indicators). This may allow the quadratic processing block 352 to perform distinct computations based on token priority, as detailed below.

FIG. 3C provides a more detailed illustration of the operations within the attention module 356 of the quadratic processing block 352 for the embodiment shown in FIG. 3B. in some embodiments, within the attention module 356, the identity of the high-priority tokens (xₕ) is used to determine or calculate Query (Q) 370 and Key (K) 372 matrices. In some embodiments, Q and K matrices may be determined based on the first set of input tokens xₕ, for example, Q=xₕ*W^{Q} and K=xₕ*W^{K}, where W^{Q} 362 and W^{K} 364 are corresponding weight matrices. In some embodiments, a Value (V) matrix 374 is determined or calculated based on the complete set of input tokens x received by the layer, for example, V=x*W^{V}, where W^{V} 366 is a value weight matrix.

In some embodiments, the attention module 356 then generates a set of attention outputs Oₐₘ 358 based on the Q matrix 370, the K matrix 372, and a portion of the V matrix corresponding to the first set (high-priority) of input tokens, denoted as Vₕ 376 (where Vₕ=xₕ*W^{V}). For example, the attention outputs Oₐₘ 358 may be calculated via a self-attention mechanism, such as Oₐₘ=softmax(QK^{T})Vₕ. These attention outputs Oₐ 358, which may represent the processed high-priority tokens, are then passed to the MLP block 308 within the quadratic processing block 352. The MLP block 308 may process the attention outputs Oₐ 358 to generate the first set of outputs O_{first} 359, which may represent the final output of the quadratic processing path for the high-priority tokens.

In some embodiments, the sub-quadratic processing block (adaptor 354) processes the second set of input tokens (xₗ). In some embodiment, intermediate values Vₗ 378 corresponding to the second set of input tokens xₗ are obtained. These intermediate values Vₗ 378 may be derived from the V matrix 374 that was determined using all input tokens x within the attention module 356. In some embodiments, Vₗ represents the portion of the V matrix corresponding to the low-priority tokens (Vₗ=xₗ*W^{V}). In some embodiments, as illustrated in FIG. 3B, Vₗ may utilize the same value weight matrix W^{V} 366 that is used in the quadratic path.

In some embodiments, these intermediate values Vₗ are then processed using an MLP block 309 to generate a set of adjustment values r 380. In some embodiments, e.g., the Fused DTRNet-Adaptor embodiment 350 shown in FIG. 3B, the MLP block 309 used for this purpose within the adaptor 354 may be the same as or a shared instance of, the MLP block 308 used in the quadratic processing block 352 (e.g., MLP 308 and MLP 309 are shared). This sharing of the MLP block may reduce the number of learnable parameters in the model. In some embodiments, the adjustment values 380 are generated as r=MLP 309(Vₗ). The adaptor block 354 may then generate the second set of outputs O_{second} by processing the second set of input tokens xₗ and the corresponding adjustment values r 380. As shown in FIG. 3B by the summation symbol, this processing may comprise combining or adding the adjustment value r to the corresponding input token xₗ (e.g., O_{second}=xₗ+r=xₗ+MLP 309(Vₗ)). In some embodiments, one or more operations by the sub-quadratic block, e.g., the adaptor block 352, may be performed in in parallel with one or more operations in the sub-quadratic block, e.g., transformer 352.

The reuse of parameters, e.g., the sharing of the MLP block, and potentially the value weight matrix W^{V} 366 may reduce the need to learn separate weights in the adaptor block 354, which may reduce the model's total parameter count, memory footprint, and potentially inference latency.

In some embodiments, the merge block 108 receives the first set of outputs O_{first} 359 (from MLP 308 in the quadratic path 352) and the second set of outputs O_{second} 360 (from the adaptor path 354). The merge block 108 may process these two sets to generate a third set of outputs O_{third} 361, representing the combined embeddings arranged based on the original order of the input tokens x, ready to be passed to the next layer of the transformer model.

According to an embodiment, based on the general DTRNet framework 100, a network architecture referred to as DTRNet-mamba may be provided. FIG. 4 illustrates a DTRNet-mamba layer, according to an embodiment. The DTRNet-mamba layer or architecture 400 includes one or more of: a router 102, an attention block 402, a mamba token mixer block (or a mamba block) 404 (similar to sub-quadratic block 106), a merging function 108 and an MLP component 406.

In some embodiments, the mamba block 404 is a sub-quadratic computational unit within the DTRNet architecture. Different from the approach in DTRNet-adaptor 300, where the lighter computational pathway operates in parallel with the entire transformer decoder layer, DTRNet-mamba integrates the mamba block 404 in parallel with the attention module 402 of the transformer decoder layer. This design may result in a hybrid decoder layer, which may improve balancing computational efficiency and performance.

As is known, mamba is an LLM architecture that integrates the structured state space sequence (S4) model to manage lengthy data sequences. The S4 model includes features of recurrent, convolutional, and continuous-time models, wherein the S4 model can effectively and efficiently simulate long-term dependencies, allowing the S4 model to handle irregularly sampled data.

In some embodiments, in the hybrid decoder layer, the mamba block 404 works in conjunction with the self-attention mechanism 402 to alleviate the high computational demands typical of standard attention modules. The process begins with an input layer normalization, followed by simultaneous or concurrent processing of the input tokens through both the self-attention block 402 and the mamba block 404. In some embodiments, the outputs from these two parallel pathways are then merged and passed through a post-attention layer normalization and a fully connected feedforward layer. This shared processing may ensure that the integrated output remains coherent and stable, which may further maintain the integrity of the token representations across both pathways.

In some embodiments, based on the DTRNet-adaptor architecture 300, tokens deemed critical or high priority by the router are sent through the computationally heavier pathway 302, while the rest are processed by the lighter adaptor block 304. In some embodiments, based on the DTRNet-mamba architecture 400, the mamba Block is designed to process all tokens without skipping any, ensuring sequential token processing which may be relevant for maintaining consistency in the model's performance. In some embodiments, in the DTRNet-mamba architecture 400, only the critical tokens (e.g., the first set of high priority tokens, xₕ) are identified and/or selected to pass through the self-attention block 402, while all tokens are processed by the mamba block 404

In some embodiments, the selection of critical tokens is controlled by the routing mechanism of DTRNet. To potentially improve effectiveness of the router during training, in some embodiments, the scores of the selected tokens are included in a gradient computation pathway. This may be achieved by multiplying the token scores with the output of the self-attention block 402. In some embodiments, during inference, a pre-trained router classifies tokens as either among the selected high priority e.g., top-k important tokens or not, facilitating the autoregressive nature of token generation while maintaining efficient processing.

In some embodiments, the DTRNet-Mamba introduces a hybrid decoder layer with a parallel structure that effectively distributes the computational workload. By ensuring that all tokens participate in the Mamba block 404 processing while only the important or high priority tokens xₕ are routed to the self-attention mechanism 402, the DTRNet-Mamba architecture may achieve a balance between computational efficiency and task accuracy.

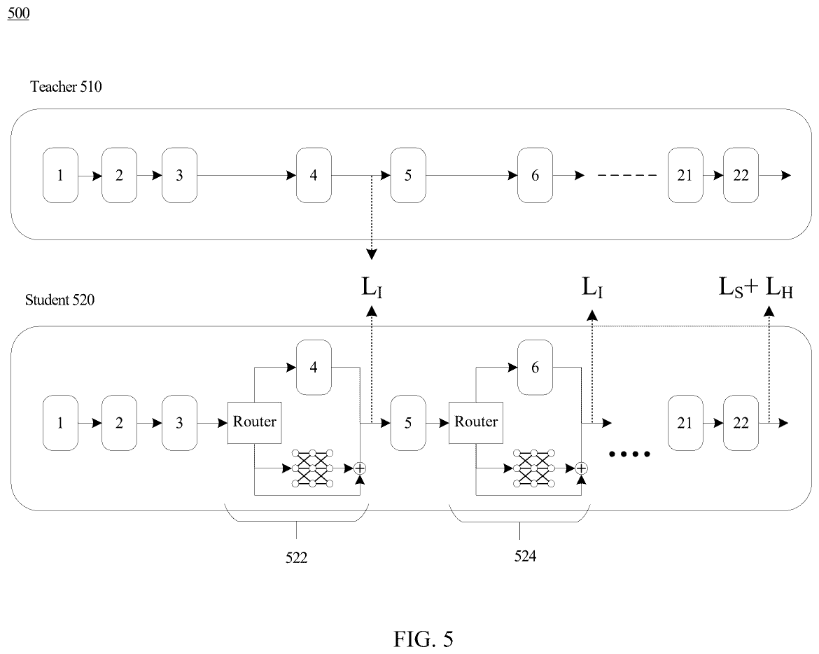

FIG. 5 illustrates an example configuration for training a DTRNet-based model using a knowledge distillation framework, according to an embodiment. The knowledge distillation setup 500 may leverage a teacher-student paradigm, where a standard transformer model 510 serves as the teacher, and the DTRNet-based model 520 acts as the student. The DTRNet-based model may be DTRNet-Adaptor based model or DTRNet-Mamba based model.

In this example, the DTRNet-based layers (e.g., layers 522 and 524) are incorporated into one or more alternate layers of the transformer-based student model 520. The teacher model 510 provides supervisory guidance by transferring its learned representations through techniques such as soft labels or intermediate layer outputs. These representations may enable the student model to approximate the teacher model's performance while utilizing fewer computational resources.

The router within the student model may dynamically select tokens for processing during training, directing them to high-priority paths (e.g., transformer block) or low-priority paths (e.g., adaptor block or mamba block). Tokens are processed based on their importance, and the outputs are combined to produce final token representations.

The knowledge distillation process may allow the student model to retain key features of the teacher model while reducing computational complexity. By alternating DTRNet-based layers with standard transformer layers, the student model may balance efficiency with performance, demonstrating scalability for large-scale deployments.

In some embodiments, the first few layers and last few layers of the student model 520 are left as transformer blocks similar to the teacher model 510. For example, the first three blocks of the student model 520 is a transformer block similar to the teacher model 510, and for block 4 of the student model, a DTRNet-block 522 is used, for example, a DTRNet-adaptor. In some embodiments, this DTRNet-block is used for every other layer (or in any appropriate order) until the last few blocks of the student model. In some embodiments, during training, both the student model 520 and the teacher model 510 receive similar inputs, and at a DTRNet-layer of the student model 520, e.g., block 522, the student model is trained so that the output at the DTRNet-layer of the student model is close to or similar to the output of a corresponding teacher layer. In some embodiment, a loss function, which may be referred to as an inner layer loss, L_{I}, may be defined and used to minimize the difference between the output of a DTRNet layer (block 522 of the student model 520) and the corresponding layer of the teacher model.

Embodiment may improve model efficiency by using conditional computation to prioritize important tokens. In some embodiments, a routing mechanism is used to select critical tokens and apply more computational resources to them while using lightweight processing for less important tokens. In some embodiments, the routing mechanism dynamically sets the number of tokens to be routed to a quadratic block and/or a sub-quadratic block.

In some embodiments, the routing mechanism dynamically allocates tokens to the quadratic block and/or sub-quadratic block based on a computational priority. In some embodiments, a regularization term is used to control the number of tokens selected for intensive processing.

In some embodiments, a model architecture is provided that has parallel processing blocks (quadratic and sub-quadratic). The parallel processing blocks may allow for concurrent processing of different tokens.

According to an embodiment, a DTRNet architecture is provided that leverages an enhanced router for dynamic allocation of tokens as described herein. This dynamic allocation may improve processing by routing the less important tokens to a sub-quadratic processor which may ensure that less important tokens are processed with lower computational resources. This may reduce overall computational load, memory usage, and power consumption without compromising performance for critical tokens.

According to some embodiments, batch inference may be provided. Batch inference (or batch processing during inference) may enable high-throughput processing and reduce inference time. Embodiments may further provide adequate generalization performance. DTRNet's design may maintain adequate generalization performance by ensuring that tokens that require full processing still pass through the complete attention mechanism. DTRNet may provide an adequate balance between efficiency and performance

Some embodiments may apply to computer vision. In some embodiments, in vision transformers, selective token routing could dynamically prioritize important image patches, which may improve processing of high-resolution images while reducing computational load for less critical regions.

Some embodiments may apply to autonomous systems. In some embodiments, the dynamic routing mechanism may improve resource allocation in self-driving cars or drones by processing only the most relevant sensor data, such as data from cameras or LIDAR, which may improve real-time efficiency.

Some embodiments may apply to speech recognition. In some embodiments, token selection methods could selectively process more critical phonemes in automatic speech recognition (ASR) systems, which may reduce latency in real-time applications, such as voice assistants.

In some embodiments, the router or routing mechanism may be implemented using any one or more of: an MLP router, attention-based routers or convolutional mechanisms to determine token importance. While embodiments describe quadratic and sub-quadratic pathways, some embodiments may use other lightweight pathways like kernel-based methods or sparse attention models to further reduce complexity while maintaining performance.

In some embodiments, batch processing techniques during inference include advanced packing algorithms, to handle dynamic token lengths, potentially improving scalability for large-scale deployments. In some embodiments, specialized accelerators may be used for token selection and processing to further enhance the DTRNet-like models.

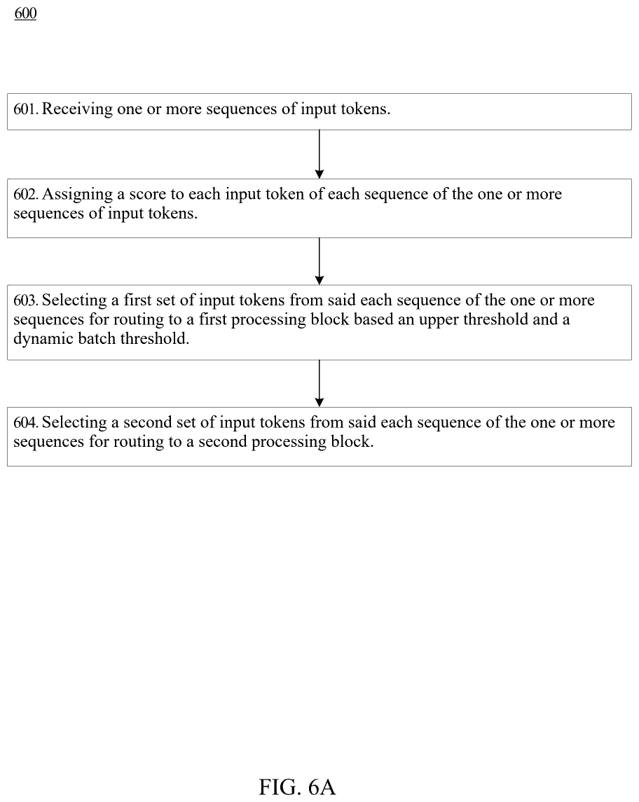

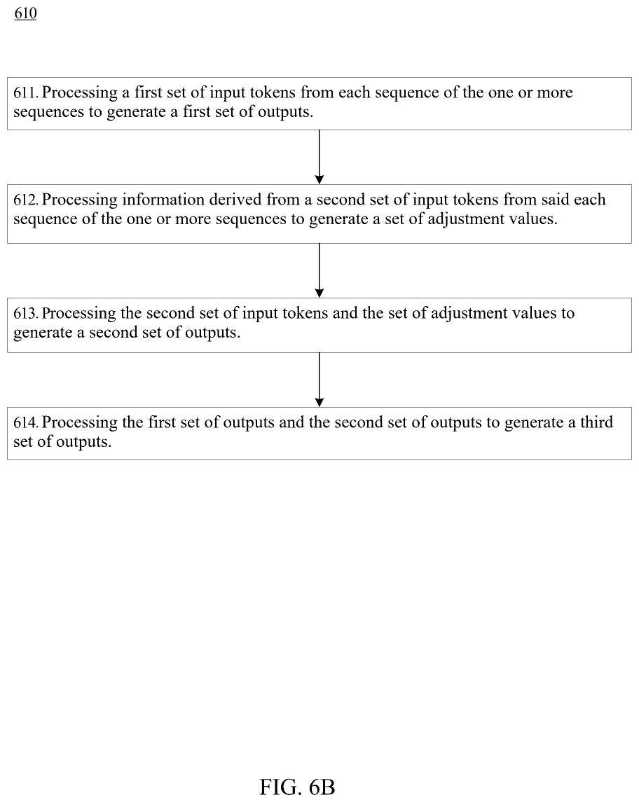

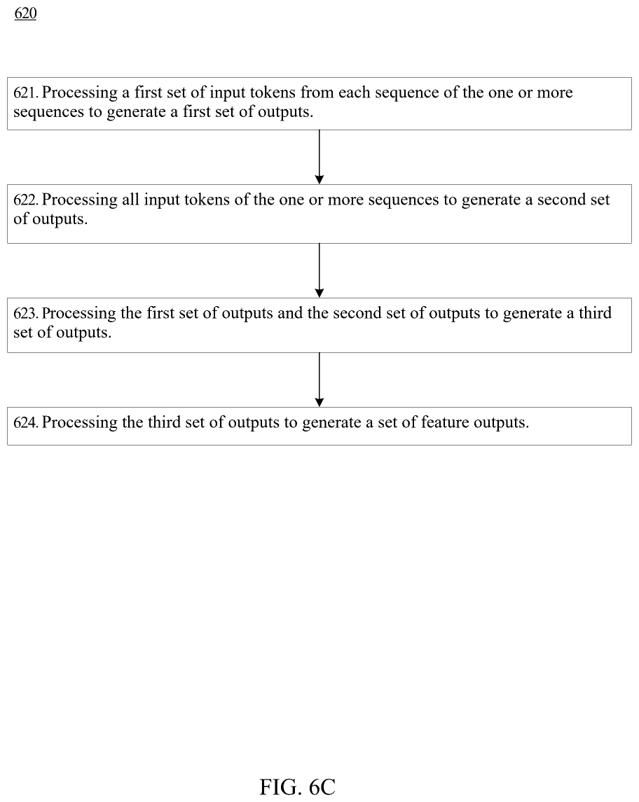

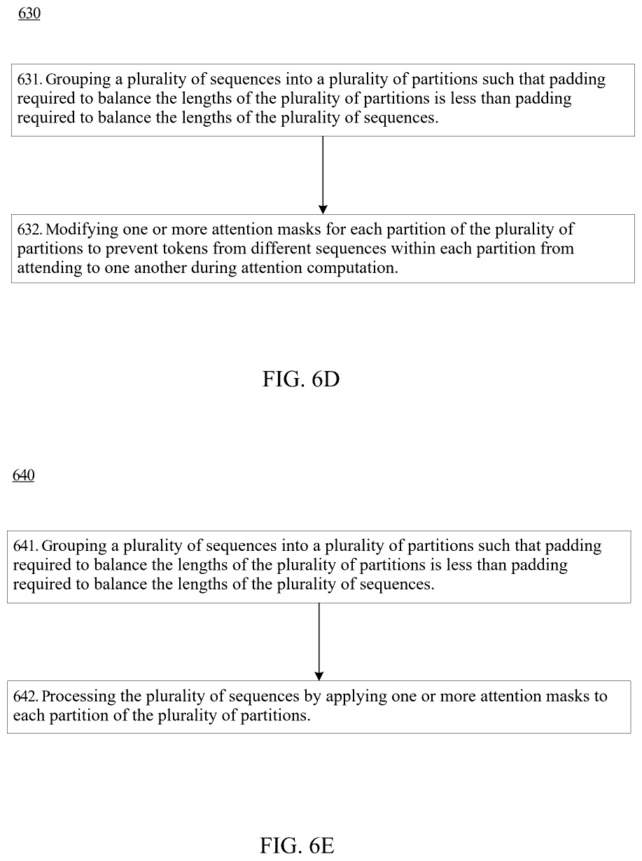

FIG. 6A illustrates a method for training a machine learning model for dynamically routing tokens, according to an embodiment. The method 600 includes receiving 601, by a machine learning model for example, one or more sequences of input tokens. The method further includes assigning 602, by the machine learning model, a score to each input token of each sequence of the one or more sequences of input tokens, the score indicating a computational priority of said each input token. The method further includes selecting 603, by the machine learning model, a first set of input tokens from said each sequence of the one or more sequences for routing to a first processing block. In some embodiments, the selecting is based on an upper threshold representing a maximum amount of input tokens from said each sequence of the one or more sequences of input tokens that can be routed to the first processing block. In some embodiments, the selecting is further based on a dynamic batch threshold representing a maximum amount of high-priority tokens in any one sequence of the one or more sequences, each high-priority token referring an input token with a score (e.g., the assigned score) exceeding a priority threshold. The method further includes selecting 604, by the machine learning model, a second set of input tokens from said each sequence of the one or more sequences for routing to a second processing block.

FIG. 6B illustrates a method for processing one or more sequences of input tokens, according to an embodiment. The method 610 may be performed by a transformer model at a layer of a plurality of layers of the transformer model. The method includes processing 611, by a quadratic processing block 104, a first set of input tokens from each sequence of the one or more sequences to generate a first set of outputs representing high-priority token embeddings associated with the first set of input tokens. The quadratic processing block may be configured to perform computation that scales quadratically with respect to a number of input tokens processed. For example, the quadratic processing block may process the first set of input tokens based on computation that scales quadratically with respect to a number of input tokens in the first set. The method further includes processing 612, by a sub-quadratic processing block 106 using a multiplayer perceptron (MLP) block, information derived from a second set of input tokens from said each sequence of the one or more sequences to generate a set of adjustment values (e.g., a set of residual vectors) associated with the second set of input tokens. Each adjustment value of the set of adjustment values (e.g., each residual vector of the set of residual vectors) may correspond to an input token of the second set of input tokens and represent an adjustment to said input token. The second set of input tokens may include input tokens other than the first set of input tokens. The method further includes processing 613, by the sub-quadratic processing block 106, the second set of input tokens and the set of adjustment values (residual vectors) to generate a second set of outputs representing low-priority token embeddings associated with the second set of input tokens. Each output of the second set of outputs may be generated based on a corresponding input token of the second set of input tokens and a corresponding adjustment of the set of adjustment values (e.g., a corresponding residual vector of the set of residual vectors corresponding to said input token of the second set of input tokens). The method further includes processing 614, by a merge block 108, the first set of outputs and the second set of outputs to generate a third set of outputs representing combined embeddings arranged based on an original order of said each sequence of the one or more sequences.

FIG. 6C illustrates another method for processing one or more sequences of input tokens, according to an embodiment. The method 620 may be performed by a transformer model at a layer of a plurality of layers of the transformer model. The method includes processing 621, by an attention block 402, a first set of input tokens from each sequence of the one or more sequences to generate a first set of outputs indicating context-aware representations of the first set of input tokens. The method further includes processing 622, by a mamba token mixer block 404, all input tokens from of the one or more sequences to generate a second set of outputs. The method further includes processing 623, by a merge block 108, the first set of outputs and the second set of outputs to generate a third set of outputs. The method further includes processing 624, by a multilayer perceptron (MLP) block 406, the third set of outputs to generate a set of feature outputs, each feature output of the set of feature outputs representing a learned feature associated with an output of the third set of outputs.

FIG. 6D illustrates a method for concurrently processing a plurality of sequences of varying lengths at a layer of a model during inference, according to an embodiment. The method may be performed by a machine learning model or an apparatus including the machine learning model. The method 630 includes grouping 631 the plurality of sequences into a plurality of partitions such that padding required to balance the lengths of the plurality of partitions is less than padding required to balance the lengths of the plurality of sequences. The method further includes modifying 632 one or more attention masks for each partition of the plurality of partitions to prevent tokens from different sequences within each partition from attending to one another during attention computation.

FIG. 6E illustrates another method for concurrently processing a plurality of sequences of varying lengths at a layer of a model during inference, according to an embodiment. The method may be performed by a machine learning model or an apparatus including the machine learning model. The method 640 includes grouping 641 the plurality of sequences into a plurality of partitions such that padding required to balance the lengths of the plurality of partitions is less than padding required to balance the lengths of the plurality of sequences. The method further includes processing 642 the plurality of sequences by applying one or more attention masks to each partition of the plurality of partitions. In some embodiments, grouping 631 or 641 the plurality of sequences into the plurality of partitions is to reduce the padding required to balance the lengths of the plurality of partitions compared to the padding required to balance the lengths of the plurality of sequences. In some embodiments, the grouping results in the plurality of partitions requiring less padding to balance (or equalize) their lengths than the padding required to balance the lengths of the plurality of sequences.

Various components, modules, blocks, functions, or other processing elements described herein may be implemented in hardware, software, or a combination thereof. Examples include a router, a machine learning model, a quadratic processing block, a sub-quadratic processing block, a merge block, an attention block, an MLP block, and a Mamba token mixer block. These elements may operate independently or in combination to perform one or more functions within a system as described herein.

As used herein, a component that is “configured to” perform a function may refer to a component that is structured, designed, or programmed to carry out the specified operation. This includes instances where the component inherently possesses the capability to perform the function, as well as instances where it is adapted, programmed, or otherwise enabled to do so through hardware, software, or a combination thereof. Further, if a component performs a function, it can be understood that the component is configured to perform that function. That is, a component that executes an operation, processes data, or otherwise carries out a task may inherently or by design be structured to do so, and as such, is considered to be configured to perform the function it executes. This applies regardless of whether the configuration is based on fixed hardware logic, programmable instructions, dynamically adjustable parameters, or a combination thereof.

A neural network may comprise a plurality of neural cells. A neural cell may be an operation unit that uses xₛ and an intercept of 1 as inputs. An output from the operation unit may be

$${h}_{W , b} ( x ) = f ( {W}^{T} x ) = f ( {\sum }_{s = 1}^{n} {W}_{s} {x}_{s} + b ) ,$$

where s=1, 2, . . . n, and n is a natural number greater than 1, Wₛ is a weight of xₛ, b is an offset of the neural cell, and f is an activation function (activation functions) of the neural cell and used to introduce a nonlinear feature to the neural network, to convert an input signal of the neural cell to an output signal. The output signal of the activation function may be used as an input to a following convolutional layer. The activation function may be a sigmoid function. The neural network is a network formed by joining a plurality of the foregoing single neural cells. In other words, an output from one neural cell may be an input to another neural cell. An input of each neural cell may be associated with a local receiving area of a previous layer, to extract a feature of the local receiving area. The local receiving area may be an area consisting of several neural cells.

A deep neural network (DNN) is also referred to as a multi-layer neural network and may be understood as a neural network with a plurality of hidden layers. The DNN is divided according to positions of different layers. The neural networks in the DNN may be classified into three categories: an input layer, a hidden layer, and an output layer. Generally, a first layer is the input layer, a final layer is the output layer, and middle layers are all hidden layers. A full connection between layers refers to adjacent layers in the DNN where each node in one of the layers is connected to each of the nodes in the next layer. A neural cell at an it layer is connected to any neural cell at an (i+1)^{th} layer.

In the process of training a deep neural network, to enable the deep neural network to output a predicted value that is as close to a truly desired value as possible, a predicted value of a current network and a truly desired target value may be compared, and a weight vector of each layer of the neural network is updated based on a difference between the predicted value and the truly desired target value. There is usually an initialization process before a first update. For example, a parameter may be preconfigured for each layer of the deep neural network. If the predicted value of a network is excessively high, the weight vector may be continuously adjusted to lower the predicted value, until the neural network can predict the truly desired target value. Therefore, an approach to compare the difference between a predicted value and target value may be via a loss function or an objective function. The loss function and the objective function may be used to measure the difference between a predicted value and a target value. For example, the loss function is used as an example. A higher output value (loss) of the loss function indicates a greater difference. In this case, training the deep neural network is a process of minimizing the loss.

In a convolutional neural network, an error back propagation (BP) algorithm may be used in a training process to revise a value of a parameter, e.g., a weight vector, of the network so that a re-setup error loss of the network is reduced or minimized. An error loss is generated in a process from forward propagation of an input signal to signal output. The parameter of the network is updated through back propagation of error loss information, so that the error loss is converged. The back propagation algorithm is a back propagation movement dominated by an error loss, and is intended to obtain a most optimal network parameter, for example, a weight matrix.

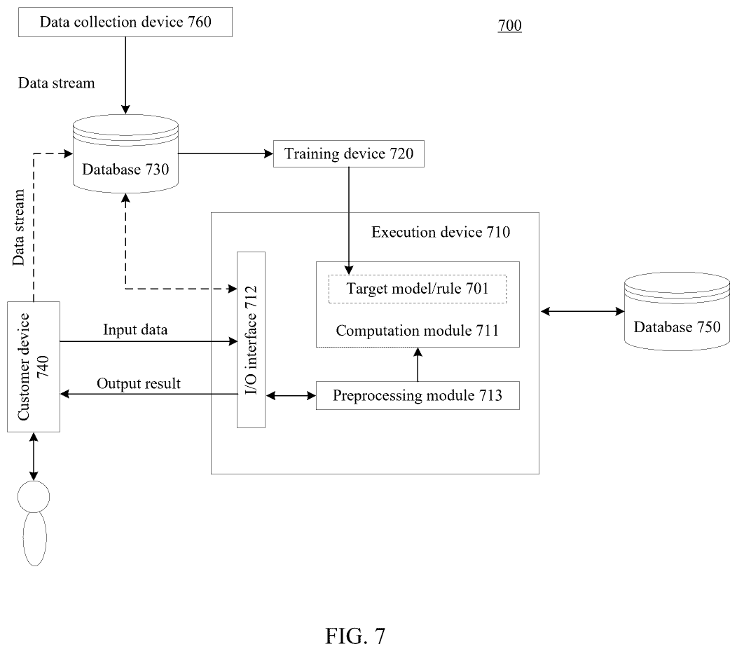

FIG. 7 is a schematic diagram of a system architecture, according to an embodiment. As shown in the system architecture 700, a data collection device 760 is configured to collect training data and store the training data into a database 730. A training device 720 generates a target model/rule 701 based on the training data maintained in the database 730. The target model/rule 701 may refer to the trained network described herein (e.g., a DTRNet model including DTRNet Adaptor or DTRNet mamba) and other networks used in the different branches.

Optionally, the one or more methods described herein may be processed by a central processing unit (CPU), or may be jointly processed by a CPU and a graphics processing unit (GPU), or may not be processed by a GPU, but processed by another processor that is applicable to neural network computation. This is not limited in this application.

The target module/rule 701 obtained through training by the training device 720 may be applied to different systems or devices, for example, applied to an execution device 710. The execution device 710 may be a terminal, for example, a mobile terminal, a tablet computer, a notebook computer, AR/VR, or an in-vehicle terminal, or may be a server, a cloud end, or the like. The execution device 710 is provided with an I/O interface 712, which is configured to perform data interaction with an external device. A user may input data to the I/O interface 712 by using a customer device 740. A preprocessing module 713 may be configured to perform preprocessing based on the input data received from the I/O interface 712.

In a process in which the execution device 710 performs preprocessing on the input data or the computation module 711 in the execution device 110 performs computation, the execution device 710 may invoke data, code, or the like from a data storage system 750, to perform corresponding processing, or may store, in a data storage system 750, data, an instruction, or the like obtained through corresponding processing. The I/O interface 712 may return a processing result to the customer device 740 and provides the processing result to the user. It should be noted that the training device 720 may generate a corresponding target model/rule 701 for different targets based on different training data.

It should be noted that FIG. 7 is merely a schematic diagram of a system architecture according to an embodiment of the present disclosure. Position relationships between the device, the component, the module, and the like that are shown do not constitute any limitation. For example, the data storage system 750 is an external memory relative to the execution device 710. In another case, the data storage system 750 may be located in the execution device 710.

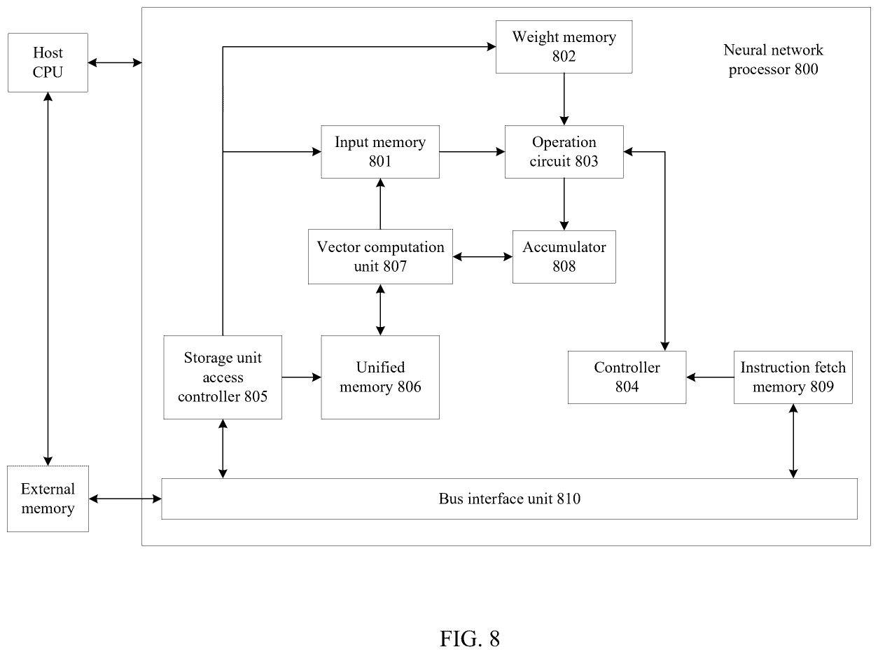

FIG. 8 illustrates a schematic diagram of a hardware structure of a chip according to an embodiment of the present disclosure. The chip includes a neural network processor 800. The chip may be provided in the execution device 710 shown in FIG. 7, to perform computation for the computation module 711. Alternatively, the chip may be provided in the training device 720 shown in FIG. 7, to perform training and output the target model/rule 701.

The neural network processor 800 may be any processor that is applicable to massive exclusive OR operations, for example, a neural processing unit (NPU), a tensor processing unit (TPU), a GPU, or the like. The NPU is used as an example. The NPU may be mounted, as a coprocessor, to a host CPU, and the host CPU may allocate a task to the NPU. A core part of the NPU is an operation circuit 803. A controller 804 controls the operation circuit 803 to extract matrix data from memories (801 and 802) and perform multiplication and addition operations.

In some implementations, the operation circuit 803 internally includes a plurality of processing units (e.g., Process Engine, PE). In some implementations, the operation circuit 803 is a bi-dimensional systolic array. In addition, the operation circuit 803 may be a unidimensional systolic array or another electronic circuit that can implement a mathematical operation such as multiplication and addition. In some implementations, the operation circuit 803 is a general matrix processor.

For example, it is assumed that there are an input matrix A, a weight matrix B, and an output matrix C. The operation circuit 803 may obtain, from a weight memory 802, weight data of the matrix B, and cache the data in each PE in the operation circuit 803. The operation circuit 803 may obtain input data of the matrix A from an input memory 801, and perform a matrix operation based on the input data of the matrix A and the weight data of the matrix B. An obtained partial or final matrix result may be stored in an accumulator (accumulator) 808.

A unified memory 806 may be configured to store input data and output data. Weight data may be directly moved to the weight memory 802 by using a storage unit access controller (e.g., Direct Memory Access Controller, DMAC) 805. The input data may also be moved to the unified memory 806 by using the DMAC.

A bus interface unit (BIU) 810 may be used for interaction between the storage unit access controller (e.g., DMAC) 805 and an instruction fetch memory (Instruction Fetch Buffer) 809. The bus interface unit 810 may further be configured to enable the instruction fetch memory 809 to obtain an instruction from an external memory. The BIU 810 may further be configured to enable the storage unit access controller 805 to obtain, from the external memory, source data of the input matrix A or the weight matrix B.

In some embodiments, the storage unit access controller (e.g., DMAC) 805 is configured to move input data from an external memory (e.g., double data rate synchronous dynamic random-access memory, DDR SDRAM) to the unified memory 806, or move the weight data to the weight memory 802, or move the input data to the input memory 801.

A vector computation unit 807 may include a plurality of operation processing units. If needed, the vector computation unit 807 may perform further processing, for example, vector multiplication, vector addition, an exponent operation, a logarithm operation, or magnitude comparison, on an output from the operation circuit 803. The vector computation unit 807 may be used for computation at a non-convolutional layer or fully-connected layers (FC, fully connected layers) of a neural network. The vector computation unit 807 may further perform processing on computation such as pooling (pooling) or normalization (normalization). For example, the vector computation unit 807 may apply a nonlinear function to an output of the operation circuit 803, for example, a vector of an accumulated value, to generate an activation value. In some implementations, the vector computation unit 807 may generate a normalized value, a combined value, or both a normalized value and a combined value.

In some implementations, the vector computation unit 807 may store a processed vector to the unified memory 806. In some implementations, the vector processed by the vector computation unit 807 may be used as activation input to the operation circuit 803, for example, to be used in a following layer of the neural network.

The instruction fetch memory (instruction fetch buffer) 809 connected to the controller 804 may be configured to store an instruction used by the controller 804. The unified memory 806, the input memory 801, the weight memory 802, and the instruction fetch memory 809 may all be on-chip memories. The external memory may be independent from the hardware architecture of the NPU.

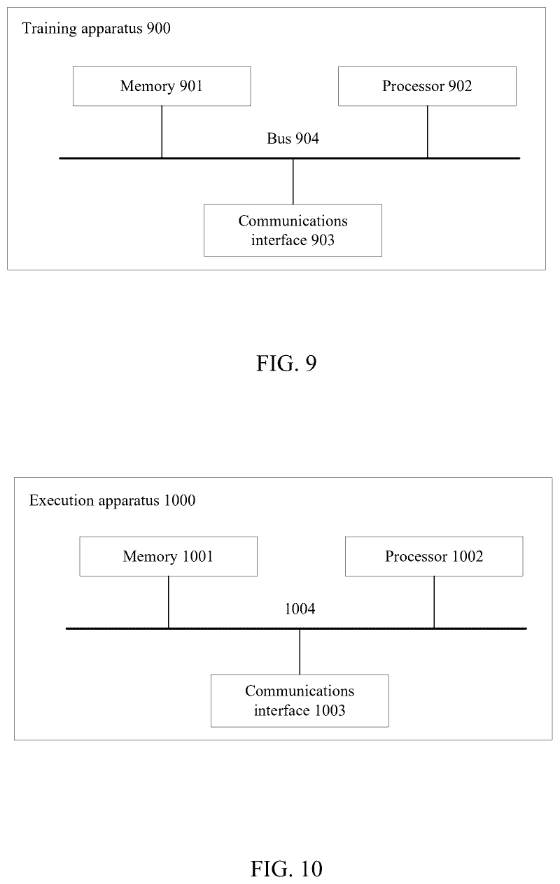

FIG. 9 illustrates a schematic diagram of a hardware structure of a training apparatus according to an embodiment of the present disclosure. A training apparatus 900 (the apparatus 900 may be a computer device and may refer to the training device 720) may include a memory 901, a processor 902, a communications interface 903, and a bus 904. A communication connection is implemented between the memory 901, the processor 902, and the communications interface 903 by using the bus 904.

The memory 901 may be a read-only memory (Read Only Memory, ROM), a static storage device, a dynamic storage device, or a random-access memory (Random Access Memory, RAM). The memory 901 may store a program. The processor 902 and the communications interface 903 may be configured to perform, when the program stored in the memory 901 is executed by the processor 902, steps of one or more embodiments described herein.

The processor 902 may be a general central processing unit (Central Processing Unit, CPU), a microprocessor, an application-specific integrated circuit (Application Specific Integrated Circuit, ASIC), a graphics processing unit (graphics processing unit, GPU), or one or more integrated circuits. The processor 902 may be configured to execute a related program to implement a function that needs to be performed by a unit in the training apparatus according to one or more embodiments described herein.

In addition, the processor 902 may be an integrated circuit chip with a signal processing capability. In an implementation process, steps of one or more training methods or embodiments described herein may be performed by an integrated logical circuit in a form of hardware or by an instruction in a form of software in the processor 902. In addition, the foregoing processor 902 may be a general-purpose processor, a digital signal processor (Digital Signal Processor, DSP), an application-specific integrated circuit (ASIC), a field programmable gate array (Field Programmable Gate Array, FPGA) or another programmable logic device, a discrete gate or a transistor logic device, or a discrete hardware assembly. The processor 902 may implement or execute the methods, steps, and logical block diagrams that are disclosed in the embodiments of this disclosure. The general-purpose processor may be a microprocessor, or the processor may be any conventional processor or the like. The embodiments described herein may be directly performed by a hardware decoding processor, or may be performed by using a combination of hardware in the decoding processor and a software module. The software module may be located in a mature storage medium in the art, such as a random-access memory, a flash memory, a read-only memory, a programmable read-only memory, an electrically erasable programmable memory, or a register. The storage medium may be located in the memory 901. The processor 902 may read information from the memory 901, and completes, by using hardware in the processor 902, the functions that need to be performed by the units included in the training apparatus according to one or more embodiment described herein.

The communications interface 903 may implement communication between the apparatus 900 and another device or communications network by using a transceiver apparatus, for example, including but not limited to a transceiver. For example, training data may be obtained by using the communications interface 903.

The bus 904 may include a path that transfers information between all the components (for example, the memory 901, the processor 902, and the communications interface 903) of the apparatus 900.

FIG. 10 illustrates a schematic diagram of a hardware structure of an execution apparatus according to an embodiment of the present disclosure. The execution apparatus may refer to the execution device 710 of FIG. 7. Execution apparatus 1000 (which may be a computer device) includes a memory 1001, a processor 1002, a communications interface 1003, and a bus 1004. A communication connection is implemented between the memory 1001, the processor 1002, and the communications interface 1003 by using the bus 1004.

The memory 1001 may be a read-only memory (Read Only Memory, ROM), a static storage device, a dynamic storage device, or a random-access memory (Random Access Memory, RAM). The memory 1001 may store a program. The processor 1002 and the communications interface 1003 are configured to perform, when the program stored in the memory 1001 is executed by the processor 1002, one or more one or more embodiments described herein.

The processor 1002 may be a general central processing unit (Central Processing Unit, CPU), a microprocessor, an application-specific integrated circuit (Application Specific Integrated Circuit, ASIC), a graphics processing unit (graphics processing unit, GPU), or one or more integrated circuits. The processor 1002 may be configured to perform one or more embodiments described herein.

In addition, the processor 1002 may be an integrated circuit chip with a signal processing capability. In an implementation process, one or more embodiments described herein may be performed by an integrated logical circuit in a form of hardware or by an instruction in a form of software in the processor 1002. In addition, the processor 1002 may be a general-purpose processor, a digital signal processor (Digital Signal Processor, DSP), an application-specific integrated circuit (ASIC), a field programmable gate array (Field Programmable Gate Array, FPGA) or another programmable logic device, a discrete gate or a transistor logic device, or a discrete hardware assembly. The general-purpose processor may be a microprocessor, or the processor may be any conventional processor or the like. The one or more embodiments described herein may be performed by a hardware decoding processor, or may be performed by using a combination of hardware in the decoding processor and a software module. The software module may be located in a mature storage medium in the art, such as a random-access memory, a flash memory, a read-only memory, a programmable read-only memory, an electrically erasable programmable memory, or a register. The storage medium may be located in the memory 1001. The processor 1002 may read information from the memory 1001, and completes, by using hardware in the processor 1002, to perform one or more embodiments described herein.

The communications interface 1003 may implement communication between the apparatus 1000 and another device or communications network by using a transceiver apparatus, for example, including but not limited to a transceiver. For example, training data in reference to one or more embodiments described herein may be obtained by using the communications interface 1003.

The bus 1004 may include a path that transfers information between all the components (for example, the memory 1001, the processor 1002, and the communications interface 1003) of the apparatus 1000.

It should be noted that, although only the memory, the processor, and the communications interface are shown in the apparatuses 900 (in FIG. 9) and 1000 (in FIG. 10), a person skilled in the art should understand that the apparatuses 900 and 1000 may further include other components that are necessary for implementing normal running. In addition, based on specific needs, a person skilled in the art should understand that the apparatuses 900 and 1000 may further include hardware components that implement other additional functions. In addition, a person skilled in the art should understand that the apparatuses 900 and 1000 may include only a component required for implementing the embodiments of the present disclosure, without a need to include all the components shown in FIG. 9 or FIG. 10.

It may be understood that the apparatus 900 is equivalent to the training device 720 in FIG. 7, and the apparatus 1000 is equivalent to the execution device 710 in FIG. 7. A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

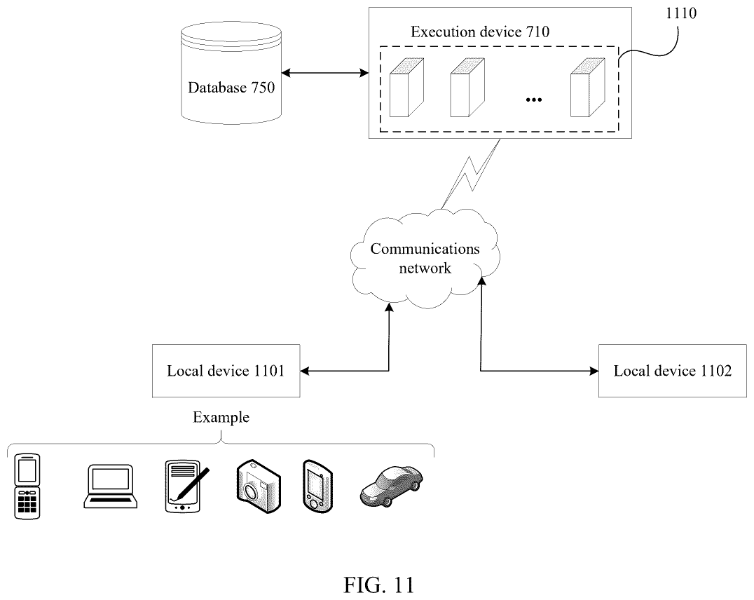

FIG. 11 illustrates a system architecture according to an embodiment of the present disclosure. The execution device 710 may be implemented by one or more servers 1110, and optionally, supported by another computation device, for example, a data memory, a router, a load balancer, or another device. The execution device 710 may be arranged in a physical station or be distributed to a plurality of physical stations. The execution device 710 may use data in a data storage system 750 or invoke program code in a data storage system 750, to implement one or more embodiments described herein.

Users may operate respective user equipment (such as a local device 1101 and a local device 1102) of the users to interact with the execution device 710. Each local device may indicate any computation device, for example, a personal computer, a computer work station, a smartphone, a tablet computer, a smart camera, a smart car, or another type of cellular phone, a media consumption device, a wearable device, a set-top box, or a game console.

The local device of each user may interact with the execution device 710 by using a communications network of any communications mechanism/communications standard. The communications network may be a wide area network, a local area network, a point-to-point connected network, or any combination thereof.

In another implementation, one or more aspects of the execution devices 710 may be implemented by each local device. For example, the local device 1101 may provide local data for the execution device 710 or feedback a computation result.

It should be noted that all functionalities of the execution device 710 may be implemented by the local device. For example, the local device 1101 may implement a function of the execution device 710 and provides a service for a user of the local device 1101, or provides a service for a user of the local device 1102.

According to embodiments, a method is provided for training a machine learning model for dynamically routing tokens. The method includes receiving, by the machine learning model, one or more sequences of input tokens. The method further includes assigning, by the machine learning model, a score to each input token of each sequence of the one or more sequences of input tokens, the score indicating a computational priority of said each input token. The method further includes selecting, by the machine learning model, a first set of input tokens from said each sequence of the one or more sequences for routing to a first processing block. In some embodiments, the selecting is based on an upper threshold representing a maximum amount of input tokens from said each sequence of the one or more sequences of input tokens that can be routed to the first processing block. In some embodiments, the selecting is further based on a dynamic batch threshold representing a maximum amount of high-priority tokens in any one sequence of the one or more sequences, each high-priority token referring an input token with a score (e.g., the assigned score) exceeding a priority threshold. The method further includes selecting, by the machine learning model, a second set of input tokens from said each sequence of the one or more sequences for routing to a second processing block.

In some embodiments, a number of the first set of input tokens is the upper threshold if the dynamic batch threshold exceeds the upper threshold. In some embodiments, a number of the first set of input tokens is the dynamic batch threshold if the dynamic batch threshold is less than or equal to the upper threshold.

In some embodiments, the machine learning model is a router for a transformer model, which includes a plurality of layers, and the method further includes updating one or more weights of the machine learning model according to a regularization term. In some embodiments, the regularization term is as follows

$${\sum }_{i = 1}^{L} {\sum }_{j = 1}^{m} {‖ {\vec{g}}_{ij} ‖}_{2}^{2} ,$$

where: L is a number of layers of the plurality of layers of the transformer model, m is a number of sequences of the one or more sequences, \vec{g}ᵢⱼ is an output score vector for the i-th layer and the j-th sequence in the one or more sequences, and

$${‖ \cdot ‖}_{2}^{2}$$

denotes squared L2 norm of the output score vector.

In some embodiments, the method further includes updating one or more weights of the transformer model based on an updated loss function as follows:

$$\begin{matrix}{L}_{new} = {L}_{orig} + \\ λ {\sum }_{i = 1}^{L} {\sum }_{j = 1}^{m} {‖ {\vec{g}}_{ij} ‖}_{2}^{2} ,\end{matrix}$$

where L_{new} is the updated loss function, L_{orig} is an original loss function of the transformer model, and λ is a scalar coefficient.

In some embodiments, the machine learning model is a router for a transformer model including a plurality of layers. In some embodiments, at least one layer of the plurality of layers includes the router configured to route the first set of input tokens from each sequence of the one or more sequences to a quadratic processing block. In some embodiments, the quadratic processing block is the first processing block and configured to perform computation that scales quadratically with respect to a number of input tokens processed. In some embodiments, the router is for routing the second set of input tokens from said each sequence of the one or more sequences to a sub-quadratic processing block. In some embodiments, the sub-quadratic processing block is the second processing block and configured to perform computation that scales sub-quadratically with respect to a number of input tokens processed.

In some embodiments, the at least one layer of the plurality of layers further includes the quadratic processing block configured to process the first set of input tokens from said each sequence of the one or more sequences to generate a first set of outputs representing high-priority token embeddings associated with the first set of input tokens. In some embodiments, the at least one layer of the plurality of layers further includes the sub-quadratic processing block configured to process the second set of input tokens from said each sequence of the one or more sequences to generate a second set of outputs representing low-priority token embeddings associated with the second set of input tokens. In some embodiments, the at least one layer of the plurality of layers further includes a merge block configured to receive the first set of outputs and the second set of outputs to generate a third set of outputs representing combined embeddings arranged based on an original order of said each sequence of the one or more sequences.

In some embodiments, the machine learning model is based on one of: a multilayer perceptron (MLP) neural network, an attention-based neural network, or a convolutional neural network (CNN).

According to embodiments, a machine learning model is provided for dynamically routing tokens. The machine learning model is trained based on receiving one or more sequences of input tokens. The machine learning model further trained based on assigning a score to each input token of each sequence of the one or more sequences of input tokens, the score indicating a computational priority of said each input token. The machine learning model is further trained based on selecting a first set of input tokens from said each sequence of the one or more sequences for routing to a first processing block. In some embodiments, the selecting is based on an upper threshold representing a maximum amount of input tokens from said each sequence of the one or more sequences of input tokens that can be routed to the first processing block. In some embodiments, the selecting is further based on a dynamic batch threshold representing a maximum amount of high-priority tokens in any one sequence of the one or more sequences, each high-priority token referring an input token with a score (e.g., the assigned score) exceeding a priority threshold. The machine learning model is further trained based on selecting a second set of input tokens from said each sequence of the one or more sequences for routing to a second processing block.

In some embodiments, a number of the first set of input tokens is the upper threshold if the dynamic batch threshold exceeds the upper threshold. In some embodiments, a number of the first set of input tokens is the dynamic batch threshold if the dynamic batch threshold is less than or equal to the upper threshold.

In some embodiments, the machine learning model is a router for a transformer model, which includes a plurality of layers. In some embodiments, the assigning the score is based on updating one or more weights of the machine learning model according to a regularization terms. In some embodiments, the regularization term is as follows

$${\sum }_{i = 1}^{L} {\sum }_{j = 1}^{m} {‖ {\vec{g}}_{ij} ‖}_{2}^{2} ,$$

where: L is a number of layers of the plurality of layers of the transformer model, m is a number of sequences of the one or more sequences, \vec{g}ᵢⱼ is an output score vector for the i-th layer and the j-th sequence in the one or more sequences, and

$${‖ \cdot ‖}_{2}^{2}$$

denotes squared L2 norm of the output score vector.

In some embodiments, the transformer model is trained based on an updated loss function including the regularization term as follows:

$${L}_{new} = {L}_{orig} + λ {\sum }_{i = 1}^{L} {\sum }_{j = 1}^{m} {‖ {\vec{g}}_{ij} ‖}_{2}^{2} ,$$

where L_{new} is the updated loss function, L_{orig} is an original loss function of the transformer model, and λ is a scalar coefficient.

In some embodiments, the machine learning model is a router for a transformer model, which includes a plurality of layers.

In some embodiments, at least one layer of the plurality of layers includes the router configured to route the first set of input tokens from each sequence of the one or more sequences to a quadratic processing block. In some embodiments, the quadratic processing block is the first processing block and configured to perform computation that scales quadratically with respect to a number of input tokens processed. In some embodiments, the router is further configured to route the second set of input tokens from said each sequence of the one or more sequences to a sub-quadratic processing block. In some embodiments, the sub-quadratic processing block is the second processing block and configured to perform computation that scales sub-quadratically with respect to a number of input tokens processed.

In some embodiments, the at least one layer of the plurality of layers further includes the quadratic processing block configured to process the first set of input tokens from said each sequence of the one or more sequences to generate a first set of outputs representing high-priority token embeddings associated with the first set of input tokens. In some embodiments, the at least one layer of the plurality of layers further includes the sub-quadratic processing block configured to process the second set of input tokens from said each sequence of the one or more sequences to generate a second set of outputs representing low-priority token embeddings associated with the second set of input tokens. In some embodiments, the at least one layer of the plurality of layers further includes a merge block configured to receive the first set of outputs and the second set of outputs to generate a third set of outputs representing combined embeddings arranged based on an original order of said each sequence of the one or more sequences.

In some embodiments, the machine learning model is based on one of: a multilayer perceptron (MLP) neural network, an attention-based neural network, or a convolutional neural network (CNN).

According to embodiments, a method is provided for processing one or more sequences of input tokens by a transformer model, where the transformer model includes a plurality of layers. The method may be performed at a layer of the plurality of layers. The method includes processing, by an attention block, a first set of input tokens from each sequence of the one or more sequences to generate a first set of outputs indicating context-aware representations of the first set of input tokens. The method further includes processing, by a mamba token mixer block, all input tokens of the one or more sequences to generate a second set of outputs. The method further includes processing, by a merge block, the first set of outputs and the second set of outputs to generate a third set of outputs. The method further includes processing, by a multilayer perceptron (MLP) block, the third set of outputs to generate a set of feature outputs, each feature output of the set of feature outputs representing a learned feature associated with an output of the third set of outputs.

In some embodiments, the processing, by the attention block, the first set of input tokens to generate the first set of outputs is performed in parallel with the processing, by the mamba token mixer block, all input tokens of the one or more sequences to generate the second set of outputs.

In some embodiments, the method further includes receiving, by a router, the one or more sequences of input tokens. In some embodiments, the method further includes assigning, by the router, a score to each input token of said each sequence of the one or more sequences of input tokens, the score indicating a computational priority of said each input token. In some embodiments, the method further includes selecting, by the router, the first set of input tokens from said each sequence of the one or more sequences for routing to the attention block, each input token of the first set of input tokens having a score (e.g., the assigned score) exceeding a priority threshold indicating a high-priority token. In some embodiments, the selecting of each input token of the first set of input tokens is based on the assigned score exceeding the priority threshold, which indicates a high-priority token. In some embodiments, the method further includes routing, by the router, the first set of input tokens to the attention block. In some embodiments, the method further includes routing, by the router, all input tokens of the one or more sequences for routing to the sub-quadratic processing block.

According to embodiments, a transformer model is provided for processing one or more sequences of input tokens. The transformer model includes a plurality of layers, and at least one layer of the plurality of layers includes an attention block configured to process a first set of input tokens from each sequence of the one or more sequences to generate a first set of outputs indicating context-aware representations of the first set of input tokens. The at least one layer of the plurality of layers further includes a mamba token mixer block configured to process a second set of input tokens from each sequence of the one or more sequences to generate a second set of outputs, the second set of input tokens including all input tokens of said each sequence of the one or more sequences. The at least one layer of the plurality of layers further includes a merge block configured to process the first set of outputs and the second set of outputs to generate a third set of outputs. The at least one layer of the plurality of layers further includes a multilayer perceptron (MLP) block configured to process the third set of outputs to generate a set of feature outputs, each feature output of the set of feature outputs representing a learned feature associated with an output of the third set of outputs.

In some embodiments, the attention block and the Mamba token mixer block are configured to process the first set of input tokens and the second set of input tokens, respectively, in parallel to generate the first set of outputs and the second set of outputs.

In some embodiments, the at least one layer of the plurality of layers further includes a router configured to receive the one or more sequences of input tokens. In some embodiments, the router is further configured to assign a score to each input token of said each sequence of the one or more sequences of input tokens, the score indicating a computational priority of said each input token. In some embodiments, the router is further configured to select the first set of input tokens from said each sequence of the one or more sequences for routing to the attention block, each input token of the first set of input tokens having a score (e.g., the assigned score) exceeding a priority threshold indicating a high-priority token. In some embodiments, the router is further configured to select each input token of the first set of input tokens based on the assigned score exceeding a priority threshold, which indicates a high priority token. In some embodiments, the router is further configured to route the first set of input tokens to the attention block. In some embodiments, the router is further configured to route the second set of input tokens from said each sequence of the one or more sequences to the sub-quadratic processing block.

According to embodiments, a method is provided for concurrently processing a plurality of sequences of varying lengths at a layer of a model during inference. The method includes grouping the plurality of sequences into a plurality of partitions such that padding required to balance the lengths of the plurality of partitions is less than padding required to balance the lengths of the plurality of sequences. The method further includes modifying one or more attention masks for each partition of the plurality of partitions to prevent tokens from different sequences within each partition from attending to one another during attention computation. In some embodiments, grouping the plurality of sequences into the plurality of partitions is to reduce the padding required to balance the lengths of the plurality of partitions compared to the padding required to balance the lengths of the plurality of sequences. In some embodiments, the grouping results in the plurality of partitions requiring less padding to balance (or equalize) their lengths than the padding required to balance the lengths of the plurality of sequences.

In some embodiments, the method further includes dynamically selecting for processing, via a router, a number of tokens from each sequence of a second plurality of sequences to generate the plurality of sequences, each sequence of the plurality of sequences having a length based on the selected number of tokens.

In some embodiments, the method further includes processing the plurality of sequences by applying the modified one or more attention masks to each partition of the plurality of partitions. In some embodiments, the grouping the plurality of sequences into a plurality of partitions is performed using a first-fit approach to assign a sequence of the plurality of sequence to a first available partition that can accommodate a length of the sequence. In some embodiments, the grouping the plurality of sequences into a plurality of partitions is further performed using a best-fit approach to place each sequence of the plurality of sequences into a partition of the plurality of partitions that results in a least amount of padding. In some embodiments, the grouping the plurality of sequences into a plurality of partitions is further performed using a polynomial-time approximation scheme (PTAS) to control trade-off between optimality and computational complexity.

According to embodiments, a method is provided for concurrently processing a plurality of sequences of varying lengths at a layer of a model during inference. The method includes grouping the plurality of sequences into a plurality of partitions such that padding required to balance the lengths of the plurality of partitions is less than padding required to balance the lengths of the plurality of sequences. The method further includes processing the plurality of sequences by applying one or more attention masks to each partition of the plurality of partitions. In some embodiments, grouping the plurality of sequences into the plurality of partitions is to reduce the padding required to balance the lengths of the plurality of partitions compared to the padding required to balance the lengths of the plurality of sequences. In some embodiments, the grouping results in the plurality of partitions requiring less padding to balance (or equalize) their lengths than the padding required to balance the lengths of the plurality of sequences.

In some embodiments, each attention mask of the one or more attention masks corresponds to a partition of the plurality of partitions and prevents tokens from different sequences within said partition from attending to one another during the processing.

In some embodiments, the method further includes modifying the one or more attention masks for each partition of the plurality of partitions to prevent tokens from different sequences within each partition from attending to one another during the processing.

According to another aspect, an apparatus is provided which includes at least one processor and at least one machine-readable medium storing instructions which when executed by the at least one processor configure the apparatus for processing one or more sequences of input tokens using a transformer model comprising a plurality of layers, wherein execution of the instructions configures the apparatus for, at a layer of the plurality of layers, performing one or more methods described herein.

According to another aspect, a (e.g., non-transitory) computer readable medium, computer program, or computer program product, includes stored thereon statements and instructions which, when executed by a computer processor perform one or more methods described herein. For example, the execution of the statements and/or instructions may cause processing one or more sequences of input tokens using a transformer model according to one or more embodiments described herein.

According to another aspect, an apparatus or system is provided, where the apparatus includes modules configured to perform one or more methods described herein. According to another aspect, another apparatus or system is provided that includes computing electronics and is configured to perform the methods described herein. According to another aspect, another apparatus is provided that includes processing and wireless communication electronics and is configured to operate as described herein.

In some embodiments a computer program product is provided. The computer program product includes a non-transitory computer readable medium having recorded thereon statements and instructions which, when executed by a computer, cause the computer to perform one or more methods described herein.

According to another aspect, a chip is provided, where the chip includes a processor and a data interface, and the processor reads, by using the data interface, an instruction stored in a memory, to perform the different aspects described herein.

Other aspects of the application provide for apparatus, and systems configured to implement the methods according to the different aspects disclosed herein. For example, wireless stations and access points can be configured with machine readable memory containing instructions, which when executed by the processors of these devices, configures the device to perform the methods disclosed herein.

In the present disclosure, the terms “a” or “an” are defined to mean “at least one”, that is, these terms do not exclude a plural number of items, unless stated otherwise. In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or another programmable device, so that computer-implemented processing is generated. Therefore, the instructions executed on the computer or another programmable device provide steps for implementing a specific function in one or more procedures in the flowcharts and/or in one or more blocks in the block diagrams.

It may be understood that division into the units in the foregoing apparatus is merely logical function division. Each function may correspond to one functional unit, or two or more functions may be integrated into one functional unit. In actual implementation, all or some of the units may be integrated into one physical entity, or may be distributed in different physical entities. In addition, the foregoing functional units may be implemented in a form of hardware, may be implemented in a form of software, or may be implemented in a form of a combination of hardware and software.

Aspects of the present disclosure can be implemented using electronics hardware, software, or a combination thereof. In some embodiments, this may be implemented by one or multiple computer processors executing program instructions stored in memory. In some embodiments, the application is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. The specification and drawings are, accordingly, to be regarded simply as an illustration of the application as defined by the appended claims, and are contemplated to cover any and all modifications, variations, combinations or equivalents that fall within the scope of the present application.

What is claimed is:

1. A method of processing one or more sequences of input tokens by a transformer model, the transformer model comprising a plurality of layers, the method comprising, at a layer of the plurality of layers:
processing, by a quadratic processing block, a first set of input tokens from each sequence of the one or more sequences to generate a first set of outputs;
processing, by a sub-quadratic processing block using a multiplayer perceptron (MLP) block, information derived from a second set of input tokens from said each sequence of the one or more sequences to generate a set of adjustment values associated with the second set of input tokens;
processing, by the sub-quadratic processing block, the second set of input tokens and the set of adjustment values to generate a second set of outputs representing low-priority token embeddings associated with the second set of input tokens, each output of the second set of outputs being generated based on a corresponding input token of the second set of input tokens and a corresponding adjustment value of the set of adjustment values; and
processing, by a merge block, the first set of outputs and the second set of outputs to generate a third set of outputs representing combined embeddings arranged based on an original order of said each sequence of the one or more sequences.

2. The method of claim 1, wherein processing, by the quadratic processing block, the first set of input tokens from each sequence of the one or more sequences to generate the first set of outputs comprises:
determining, using an attention block, a Q matrix and a K matrix based on the first set of input tokens;
determining, using the attention block, a V matrix based on all input tokens of the one or more sequences;
generating a set of attention outputs based on the Q matrix, the K matrix, and a portion of the V matrix corresponding to the first set of input tokens; and
processing, using the MLP block, the set of attention outputs to generate the first set of outputs.

3. The method of claim 1, wherein processing information derived from the second set of input tokens comprises:
obtaining intermediate values based at least in part on the second set of input tokens, wherein the intermediate values are based on a V matrix determined by the quadratic processing block and based on all input tokens of the one or more sequences; and
processing said intermediate values using the MLP block to generate the set of adjustment values.

4. The method of claim 1 further comprising:
receiving, by a router, the one or more sequences of input tokens;
assigning, by the router, a score to each input token of said each sequence of the one or more sequences of input tokens, the score indicating a computational priority of said each input token;
identifying, by the router, the first set of input tokens from said each sequence of the one or more sequences, each input token of the first set of input tokens having a score exceeding a priority threshold; and
identifying, by the router, the second set of input tokens from said each sequence of the one or more sequences.

5. The method of claim 4 further comprising: routing the first set of input tokens to the quadratic processing block, and routing the second set of input tokens to the sub-quadratic processing block.

6. The method of claim 4 further comprising:
routing the second set of input tokens to the sub-quadratic processing block; and
routing the one or more sequences to the quadratic processing block, wherein the first set of input tokens is indicated to the quadratic processing block.

7. The method of claim 4, wherein the router is trained based on:
selecting, by the router, the first set of input tokens from said each sequence of the one or more sequences based on:
an upper threshold representing a maximum amount of input tokens from said each sequence of the one or more sequences of input tokens that can be part of the first set of input tokens; and
a dynamic batch threshold representing a maximum amount of high-priority tokens in any one sequence of the one or more sequences, each high-priority token referring an input token with the score exceeding the priority threshold, wherein a number of the first set of input tokens is one of:
the upper threshold if the dynamic batch threshold exceeds the upper threshold; and
the dynamic batch threshold if the dynamic batch threshold is less than or equal to the upper threshold.

8. The method of claim 7, wherein the router is machine learning model that is further trained based on updating one or more weights of the machine learning model according to a regularization term as follows:
$${\sum }_{i = 1}^{L} {\sum }_{j = 1}^{m} {‖ {\vec{g}}_{ij} ‖}_{2}^{2}$$
where:
L is a number of layers of the plurality of layers of the transformer model;
m is a number of sequences of the one or more sequences;
\vec{g}ᵢⱼ is an output score vector for the i-th layer the transformer model and the j-th sequence in the one or more sequences; and
$${‖ \cdot ‖}_{2}^{2}$$
denotes squared L2 norm of the output score vector.

9. A transformer model comprising a plurality of layers for processing one or more sequences of input tokens, at least one layer of the plurality of layers including:
a quadratic processing block configured to process a first set of input tokens from each sequence of the one or more sequences to generate a first set of outputs;
a sub-quadratic processing block configured to:
process, using a multilayer perceptron (MLP) block, information derived from a second set of input tokens from said each sequence of the one or more sequences to generate a set of adjustment values associated with the second set of input tokens; and
process, the second set of input tokens and the set of adjustment values to generate a second set of outputs representing low-priority token embeddings associated with the second set of input tokens, each output of the second set of outputs being generated based on a corresponding input token of the second set of input tokens and a corresponding adjustment value of the set of adjustment values; and
a merge block configured to process the first set of outputs and the second set of outputs to generate a third set of outputs representing combined embeddings arranged based on an original order of said each sequence of the one or more sequences.

10. The transformer model of claim 9, wherein the quadratic processing block comprises an attention block and an MLP block, and wherein the quadratic processing block is configured to:
determine, using the attention block, a Q matrix and a K matrix based on the first set of input tokens;
determine, using the attention block, a V matrix based on all input tokens of the one or more sequences;
generate a set of attention outputs based on the Q matrix, the K matrix, and a portion of the V matrix corresponding to the first set of input tokens; and
process, using the MLP block, the set of attention outputs to generate the first set of outputs.

11. The transformer model of claim 9, wherein the sub-quadratic processing block is configured to process information derived from the second set of input tokens by:
obtaining intermediate values based at least in part on the second set of input tokens, wherein the intermediate values are based on a V matrix determined by the quadratic processing block based on all input tokens of the one or more sequences; and
processing said intermediate values using the MLP block to generate the set of adjustment values.

12. The transformer model of claim 9, wherein the at least one layer of the plurality of layers further includes a router configured to:
receive the one or more sequences of input tokens;
assign a score to each input token of said each sequence of the one or more sequences of input tokens, the score indicating a computational priority of said each input token;
identify the first set of input tokens from said each sequence of the one or more sequences, each input token of the first set of input tokens having a corresponding score exceeding a priority threshold; and
identify the second set of input tokens from said each sequence of the one or more sequences.

13. The transformer model of claim 12, wherein the router is further configured to: route the first set of input tokens to the quadratic processing block, and route the second set of input tokens to the sub-quadratic processing block.

14. The transformer model of claim 12, wherein the router is further configured to:
route the second set of input tokens to the sub-quadratic processing block; and
route the one or more sequences to the quadratic processing block, wherein the first set of input tokens is indicated to the quadratic processing block.

15. An apparatus comprising at least one processor and at least one machine-readable medium storing instructions which when executed by the at least one processor configure the apparatus for processing one or more sequences of input tokens using a transformer model comprising a plurality of layers, wherein execution of the instructions configures the apparatus for, at a layer of the plurality of layers:
processing, by a quadratic processing block, a first set of input tokens from each sequence of the one or more sequences to generate a first set of outputs;
processing, by a sub-quadratic processing block using a multiplayer perceptron (MLP) block, information derived from a second set of input tokens from said each sequence of the one or more sequences to generate a set of adjustment values associated with the second set of input tokens;
processing, by the sub-quadratic processing block, the second set of input tokens and the set of adjustment values to generate a second set of outputs representing low-priority token embeddings associated with the second set of input tokens, each output of the second set of outputs being generated based on a corresponding input token of the second set of input tokens and a corresponding adjustment value of the set of adjustment values; and
processing, by a merge block, the first set of outputs and the second set of outputs to generate a third set of outputs representing combined embeddings arranged based on an original order of said each sequence of the one or more sequences.

16. The apparatus of claim 15, wherein processing, by the quadratic processing block, the first set of input tokens from each sequence of the one or more sequences to generate the first set of outputs comprises:
determining, using an attention block, a Q matrix and a K matrix based on the first set of input tokens;
determining, using the attention block, a V matrix based on all input tokens of the one or more sequences;
generating a set of attention outputs based on the Q matrix, the K matrix, and a portion of the V matrix corresponding to the first set of input tokens; and
processing, using an MLP block, the set of attention outputs to generate the first set of outputs.

17. The apparatus of claim 15, wherein processing information derived from the second set of input tokens comprises:
obtaining intermediate values based at least in part on the second set of input tokens, wherein the intermediate values are based on a V matrix determined based on all input tokens of the one or more sequences; and
processing said intermediate values using the MLP block to generate the set of adjustment values.

18. The apparatus of claim 15, wherein execution of the instructions further configures the apparatus for:
receiving, by a router, the one or more sequences of input tokens;
assigning, by the router, a score to each input token of said each sequence of the one or more sequences of input tokens, the score indicating a computational priority of said each input token;
identifying, by the router, the first set of input tokens from said each sequence of the one or more sequences, each input token of the first set of input tokens having a score exceeding a priority threshold; and
identifying, by the router, the second set of input tokens from said each sequence of the one or more sequences.

19. The apparatus of claim 15, where execution of the instructions further configures the apparatus for:
routing the first set of input tokens to the quadratic processing block; and
routing the second set of input tokens to the sub-quadratic processing block.

20. The apparatus of claim 15, wherein execution of the instructions further configures the apparatus for:
routing the second set of input tokens to the sub-quadratic processing block; and
routing the one or more sequences to the quadratic processing block, wherein the first set of input tokens is indicated in the one or more sequences routed to the quadratic processing block.
